(19) United States
(12) Patent Application Publication
(10) Pub. No.: US 2023/0022864 A1
(43) Pub. Date: Jan. 26, 2023

(54) SERVER SYSTEM AND SYSTEM

(71) Applicant: BANDAI NAMCO ENTERTAINMENT INC., Tokyo (JP)

(72) Inventors: Makoto KIKUCHI, Tokyo (JP); Kentaro HOMMA, Tokyo (JP); Ayami YASUMOTO, Kawasaki-shi (JP); Matthew DATUM, Tokyo (JP); Akio ONDA, Warabi-shi (JP)

(73) Assignee: BANDAI NAMCO ENTERTAINMENT INC., Tokyo (JP)

(21) Appl. No.: 17/957,226

(22) Filed: Sep. 30, 2022

Related U.S. Application Data
(63) Continuation of application No. PCT/JP2021/010399, filed on Mar. 15, 2021.

(30) Foreign Application Priority Data
Mar. 30, 2020 (JP) 2020-061567
Mar. 30, 2020 (JP) 2020-061568

(51) Int. Cl. A63F 13/69; A63F 13/5378; A63F 13/48; A63F 13/44; A63F 13/216; A63F 13/847

(52) U.S. Cl. CPC A63F 13/69; A63F 13/5378; A63F 13/48; A63F 13/44; A63F 13/216; A63F 13/847; A63F 2300/8082

(57) ABSTRACT

A computer system controls a start of a gathering event that gathers a user character of a participating user at a given gathering place in a virtual space upon acceptance of a gathering request operation from a terminal of a directing user. The computer system controls a display of a map image displaying the gathering place in the virtual space in an identifiable display mode on the terminals of the directing user and the participating user. The computer system determines a success/failure of the gathering event using a position of the user character operated by the participating user. The computer system gives a given reward to the directing user and/or the participating user when the gathering event is determined to be a success in the event success/failure determination.

### CROSS REFERENCE TO RELATED APPLICATION

This application is a continuation of International Patent Application No. PCT/JP2021/010399, having an international filing date of Mar. 15, 2021, which designated the United States, the entirety of which is incorporated herein by reference. Japanese Patent Application No. 2020-061568 filed on Mar. 30, 2020 and Japanese Patent Application No. 2020-061567 filed on Mar. 30, 2020 are also incorporated herein by reference in its entirety.

### BACKGROUND

There have been known games that a player enjoys by freely moving his/her player character in a game space, as disclosed in Japanese Unexamined Patent Application Publication No. 2017-55995. Games with a wide game space, or a map, are called open world games that the player can enjoy a game world as if to make a journey and have adventures.

Moreover, there have been known games that is played by a user using a terminal having a positioning function and that progresses using a measured position of the terminal as a user position. For example, Japanese Unexamined Patent Application Publication No. 2013-59573 discloses a technique relating to an augmented reality (AR) game using measured position information.

Games allowing a player character to freely move in a game space include multi-play games allowing a plurality of players to participate in and enjoy by sharing the game space. The player can have adventurous fun more as the game space becomes wider. However, in circumstances where the plurality of players individually play the game as they please, distances among positions of player characters become long, which decreases opportunities for the player characters to encounter. In such a case, friends can communicate through chat to make their player characters meet. However, unacquainted players without such opportunities cannot enjoy acting together or meeting. The strangers cannot gather together in the first place.

This is a problem not only for game content, but also for any content where users enjoy operating their user characters in a virtual space that the users share or use to play together.

With a game disclosed in Japanese Unexamined Patent Application Publication No. 2013-59573, users can enjoy the game while freely moving in a real space as a play field. However, in the circumstances where the plurality of users individually play the game as they please, the distances among the users become long, which decreases opportunities for the users to encounter each other. In such a case, friends can communicate through chat to meet. However, unacquainted users without such opportunities cannot enjoy acting together or meeting. The unacquainted users cannot gather together in the first place.

This is a problem not only for the game content, but also for any content where users each using a user terminal having a positioning function enjoy with the real space as the play field.

### BRIEF DESCRIPTION OF DRAWINGS

FIG. 1 is a diagram illustrating an example of a general configuration of a game system.

FIG. 2 is a diagram illustrating an example of a device configuration of a user terminal.

FIG. 3 is a diagram illustrating an example of a data configuration of event definition data according to a first embodiment.

FIG. 4 is a diagram illustrating an example of a fulfillment condition according to the first embodiment.

FIG. 5 is a diagram illustrating an example of reward data according to the first embodiment.

FIG. 6 is a diagram illustrating another example of the reward data according to the first embodiment.

FIG. 7 is a diagram illustrating an example of a map image according to the first embodiment.

FIG. 8 is a diagram illustrating an example of a detail screen for a participant according to the first embodiment.

FIG. 9 is a diagram illustrating an example of a detail screen for a director according to the first embodiment.

FIG. 10 is a diagram illustrating an example of a view image according to the first embodiment.

FIG. 11 is a block diagram illustrating an example of a functional configuration of a server system according to the first embodiment.

FIG. 12 is a diagram illustrating an example of a data configuration of user management data according to the first embodiment.

FIG. 13 is a diagram illustrating an example of a data configuration of ongoing gathering event data according to the first embodiment.

FIG. 14 is a block diagram illustrating an example of a functional configuration of a user terminal according to the first embodiment.

FIG. 15 is a flowchart illustrating a flow of processes in the server system according to the first embodiment.

FIG. 16 is a diagram illustrating an example of a functional configuration of the user terminal according to a modification example 1 of the first embodiment.

FIG. 17 is a diagram illustrating an example of an announcement screen according to a modification example 2 of the first embodiment.

FIG. 18 is a diagram illustrating an outline of a game according to a second embodiment.

FIG. 19 is a diagram illustrating an example of a data configuration of the event definition data according to the second embodiment.

FIG. 20 is a diagram illustrating an example of a participation condition according to the second embodiment.

FIG. 21 is a diagram illustrating an example of a fulfillment condition according to the second embodiment.

FIG. 22 is a diagram illustrating another example of the fulfillment condition according to the second embodiment.

FIG. 23 is a diagram illustrating an example of reward data according to the second embodiment.

FIG. 24 is a diagram illustrating another example of the reward data according to the second embodiment.

FIG. 25 is a diagram illustrating another example of the reward data according to the second embodiment.

FIG. 26 is a diagram illustrating another example of the reward data according to the second embodiment.

FIG. 27 is a diagram illustrating an example of a map image according to the second embodiment.

FIG. 28 is a diagram illustrating an example of a detail screen for a participant according to the second embodiment.

FIG. 29 is a diagram illustrating an example of a detail screen for a director according to the second embodiment.

FIG. 30 is a diagram illustrating an example of a view image according to the second embodiment.

FIG. 31 is a block diagram illustrating an example of a functional configuration of a server system according to the second embodiment.

FIG. 32 is a diagram illustrating an example of a data configuration of user management data according to the second embodiment.

FIG. 33 is a diagram illustrating an example of a data configuration of map data according to the second embodiment.

FIG. 34 is a diagram illustrating an example of a data configuration of ongoing gathering event data according to the second embodiment.

FIG. 35 is a block diagram illustrating an example of a functional configuration of a user terminal according to the second embodiment.

FIG. 36 is a flowchart illustrating a flow of processes in the server system according to the second embodiment.

FIG. 37 is a diagram illustrating an example of a functional configuration of the user terminal according to a modification example 1 of the second embodiment.

FIG. 38 is a diagram illustrating an example of the announcement screen according to a modification example 3 of the second embodiment.

### DESCRIPTION OF EXEMPLARY EMBODIMENTS

The following disclosure provides many different embodiments, or examples, for implementing different features of the provided subject matter. These are, of course, merely examples and are not intended to be limiting. In addition, the disclosure may repeat reference numerals and/or letters in the various examples. This repetition is for the purpose of simplicity and clarity and does not in itself dictate a relationship between the various embodiments and/or configurations discussed. Further, when a first element is described as being “connected” or “coupled” to a second element, such description includes embodiments in which the first and second elements are directly connected or coupled to each other, and also includes embodiments in which the first and second elements are indirectly connected or coupled to each other with one or more other intervening elements in between.

In accordance with one of some embodiments, there is provided a computer system comprising at least one processor or circuit programmed to perform:

a start control to control a start of a gathering event upon acceptance of a gathering request operation from a terminal of a directing user, the gathering event including any one of a first gathering event that gathers a user character of a participating user at a given gathering place in a virtual space and a second gathering event that gathers the participating user at a given gathering place existing in a real space;

a map image display control to control a display of a map image displaying the gathering place in an identifiable display mode on the terminal of the directing user and a terminal of the participating user;

an event success/failure determination to determine a success/failure of the gathering event; and

reward giving to give a given reward to at least one of the directing user and the participating user when the gathering event is determined to be a success in the event success/failure determination.

As a result, in some embodiments, the gathering event for the predetermined participating user can be started in response to the gathering request operation by the directing user. The gathering event includes the first gathering event that gathers the user character of the participating user at the given gathering place in the virtual space and the second gathering event that gathers the participating user at the given gathering place existing in the real space. The participating user operates his/her user character to gather his/her user character at the gathering place in the virtual space. Alternatively, the participating user gathers at the given gathering place existing in the real space. When the gathering event is successfully accomplished, the reward is given to the directing user and/or the participating user. This can implement new interest relating to the user gathering.

According to a second aspect of the present disclosure, the start control in the computer system may include controlling the start of the first gathering event,

the map image display control may include controlling the display of the map image related to the virtual space,

and the event success/failure determination may include determining the success/failure of the gathering event using a position of the user character operated by the participating user.

As a result, in some embodiments, the gathering event that gathers the user character of the participating user at the given gathering place in the virtual space can be implemented. The participating user operates his/her user character to gather his/her user character at the gathering place in the virtual space. Accordingly, a system for executing the event for gathering the user characters of the plurality of users is implemented while the plurality of users enjoy content of operating the user characters in the virtual space that the plurality of users share. This can implement the new interest.

According to a third aspect of the present disclosure, the start control in the computer system may include setting, as a fulfillment condition of the gathering event, a condition related to actions of the user character of the participating user in the virtual space taken before the user character gathers at the gathering place,

and the event success/failure determination may include determining whether the user character of the participating user satisfies the fulfillment condition.

As a result, in some embodiments, the success/failure of the gathering event can be determined in consideration of the actions of the user character before the user character of the participating user gathers at the gathering place.

Further, according to a fourth aspect of the present disclosure, the start control in the computer system may include setting the fulfillment condition for each participating user based on intimacy between the participating user and the directing user.

As a result, in some embodiments, the fulfillment condition relating to the actions of the user character before the user character of the participating user gathers at the gathering place can be set for each participating user in accordance with the intimacy with respect to the directing user. For example, a degree of difficulty of the fulfillment condition can be lowered for the participating user having higher intimacy with respect to the directing user.

Further, according to a fifth aspect of the present disclosure, the start control in the computer system may include

displaying, upon acceptance of the gathering request operation, the fulfillment condition of the gathering event with the gathering place on the terminal of a predetermined target user to announce execution of the gathering event, accepting a participation operation from the terminal of the target user, and controlling the start of the gathering event with the target user who has performed the participation operation as the participating user.

As a result, in some embodiments, the participating user can be determined by making the announcement of the gathering event to invite the participation in the gathering event.

According to a sixth aspect of the present disclosure, the at least one processor or circuit in the computer system may be further programmed to perform

a first participation status display control to display at least one of the fulfillment condition and a fulfilled status of the fulfillment condition on the terminal of the participating user in association with a display of the gathering place in the map image.

As a result, in some embodiments, the fulfillment condition and/or the fulfilled status of the fulfillment condition can be shown to the participating user during the gathering event.

According to a seventh aspect of the present disclosure, the at least one processor or circuit in the computer system may be further programmed to perform

a second participation status display control to display at least one of a remaining distance to the gathering place from the user character of the participating user and a position of the participating user in a ranking of the remaining distance of each participating user on the terminal of the participating user in association with a display of the gathering place in the map image.

As a result, in some embodiments, the remaining distance to the gathering place from the user character, and/or the position in the ranking of the remaining distance among the participating users can be shown to the participating user during the gathering event.

According to an eighth aspect of the present disclosure, the event success/failure determination in the computer system may include determining the success/failure of the gathering event using the position of the user character operated by the participating user before a given gathering time or at the given gathering time.

As a result, in some embodiments, the success/failure of the gathering event can be determined based on whether the user character of the participating user moved to the gathering place by the gathering time. Alternatively, the success/failure of the gathering event can be determined based on whether the user character of the participating user is at the gathering place at the gathering time.

According to a ninth aspect of the present disclosure, the at least one processor or circuit in the computer system may be further programmed to perform

a third participation status display control to display at least one of the gathering time and a remaining time to the gathering time on the terminal of the participating user in association with a display of the gathering place in the map image.

As a result, in some embodiments, the gathering time and/or the remaining time to the gathering time can be shown to the participating user during the gathering event.

According to a tenth aspect of the present disclosure,

the map image display control in the computer system may include changing a display mode of the gathering place in the map image in accordance with a remaining time to the gathering time for the terminal of each participating user.

As a result, in some embodiments, the display of the gathering place in the map image of the virtual space can be more distinct as the remaining time to the gathering time becomes shorter, for example.

According to an eleventh aspect of the present disclosure, the computer system may comprise:

each of the user is associated with a team to belong to, and the start control includes controlling the start of the gathering event with a user on a same team as the directing user as the participating user upon acceptance of the gathering request operation.

As a result, in some embodiments, when each of the plurality of users is associated with the team to belong to, and the directing user performs the gathering request operation, the gathering event can be started with the user on the same team as the directing user as the participating user.

According to a twelfth aspect of the present disclosure, the at least one processor or circuit in the computer system may be further programmed to perform

a gathering status display control to display a gathering status of each participating user based on a remaining distance to the gathering place from the user character of the participating user on the terminal of the directing user in association with a display of the gathering place in the map image.

As a result, in some embodiments, the gathering status of each user can be shown to the directing user during the gathering event.

According to a thirteenth aspect of the present disclosure, the reward giving in the computer system may include executing a given event as the reward.

As a result, in some embodiments, the content of the reward can be set to the execution of the given event, and the event can be executed at predetermined timing.

According to a fourteenth aspect of the present disclosure, the start control in the computer system may include setting the gathering place based on an instruction from the directing user.

As a result, in some embodiments, the directing user who performs the gathering request operation can specify the gathering place for the gathering event.

According to a fifteenth aspect of the present disclosure, the map image display control in the computer system may include changing a display mode of the gathering place in the map image in accordance with a remaining distance to the gathering place from the user character of the participating user for the terminal of each participating user.

As a result, in some embodiments, the display of the gathering place in the map image of the virtual space can be more distinct as the remaining distance to the gathering place from the user character of the participating user becomes shorter, for example.

According to a sixteenth aspect of the present disclosure, the at least one processor or circuit in the computer system may be further programmed to perform

position acquiring to acquire a user position that is a position of the terminal;

the start control includes controlling the start of the second gathering event,

the map image display control includes controlling the display of the map image related to the real space, and

the event success/failure determination includes determining the success/failure of the gathering event using a gathering condition set based on the user position of the participating user.

As a result, in some embodiments, the gathering event that gathers the participating user at the given gathering place existing in the real space can be implemented. The participating user actually moves to the gathering place during the gathering event. When the gathering event is successfully accomplished, the reward is given to the directing user and/or the participating user. Accordingly, a system for executing the gathering event for gathering the users is implemented while the users enjoy content of a game or the like using the real space as a play field. This can implement the new interest.

According to a seventeenth aspect of the present disclosure, the computer system may comprise,

the gathering condition includes a position condition specifying that the user position of the participating user arrives at the gathering place, and

the event success/failure determination includes determining whether the user position of the participating user satisfies the position condition.

As a result, in some embodiments, the success/failure of the gathering event can be determined based on whether the user position of the participating user arrived at the gathering place.

According to an eighteenth aspect of the present disclosure, the computer system may comprise,

the gathering condition includes a fulfillment condition of the gathering event relating to at least one of actions of the participating user and a progress status of the gathering event before the user position of the participating user arrives at the gathering place, and

the event success/failure determination includes determining whether the participating user satisfies the fulfillment condition.

As a result, in some embodiments, the success/failure of the gathering event can be determined in consideration of the actions of the participating user or the progress status of the gathering event before the user position of the participating user arrives at the gathering place.

According to a nineteenth aspect of the present disclosure, the start control in the computer system may include setting the fulfillment condition for each participating user based on a relationship between the participating user and the directing user.

As a result, in some embodiments, the fulfillment condition relating to the actions of the participating user or the progress status of the gathering event before the user position of the participating user arrives at the gathering place can be set for each participating user in accordance with the relationship with the directing user.

According to a twentieth aspect of the present disclosure, the computer system may comprise

the fulfillment condition includes a degree of difficulty set beforehand, and

the reward giving includes giving a reward corresponding to the degree of difficulty to the participating user.

As a result, in some embodiments, a more splendid reward can be given in the gathering event including the fulfillment condition having a higher degree of difficulty.

According to a twenty first aspect of the present disclosure, the computer system may comprise

the gathering condition includes a gathered number condition specifying a number of the participating users who arrived at the gathering place, and

the event success/failure determination includes determining whether the number of the participating users satisfies the gathered number condition.

As a result, in some embodiments, the success/failure of the gathering event can be determined in consideration of the number of participating users who arrived at the gathering place.

According to a twenty-second aspect of the present disclosure, the computer system may further comprise the at least one processor or circuit is further programmed to perform

a first accomplishment degree determination to determine an accomplishment degree of the gathering condition based on the number of the participating users; and

the reward giving includes giving a reward corresponding to the accomplishment degree determined in the first accomplishment degree determination to at least one of the directing user and the participating user.

As a result, in some embodiments, the accomplishment degree of the gathering event can be determined based on the number of participating users who arrived at the gathering place, and the content of the reward to be given can be made different in accordance with the accomplishment degree. For example, a more splendid reward can be given as the number of participating users becomes larger.

According to a twenty-third aspect of the present disclosure, the at least one processor or circuit in the computer system may be further programmed to perform

a second accomplishment degree determination to calculate, for each participating user, an accomplishment degree of the gathering condition based on an arrival time of the participating user at the gathering place; and

the reward giving includes giving a reward corresponding to the accomplishment degree of the participating user determined in the second accomplishment degree determination to the participating user.

As a result, in some embodiments, the accomplishment degree of the gathering event can be determined based on the arrival time at the gathering place, and the content of the reward to be given can be made different in accordance with the accomplishment degree. For example, a more splendid reward can be given as the time taken to satisfy the gathering condition becomes shorter.

According to a twenty-fourth aspect of the present disclosure, the reward giving in the computer system may include executing a given event as the reward.

As a result, in some embodiments, the content of the reward can be set to the execution of the given event, and the event that is different from the gathering event can be executed, for example.

According to a twenty-fifth aspect of the present disclosure, the reward giving in the computer system may include giving a service reward that provides a given service set to the gathering place by a given advertiser as the reward.

As a result, in some embodiments, the content of the reward can be set to the service that the user can receive at the gathering place.

According to a twenty-sixth aspect of the present disclosure, the at least one processor or circuit in the computer system may be further programmed to perform

storing event definition data including gathering condition data specifying content of the gathering condition and reward data specifying content of the reward in association with a position in the real space set as the gathering place;

the start control includes accepting a selection operation of the event definition data from the terminal of the directing user, and controlling the start of the gathering event with the position in the real space associated with the event definition data selected as the gathering place,

the event success/failure determination includes determining the success/failure of the gathering event in accordance with the gathering condition data in the event definition data selected, and

the reward giving includes giving the reward in accordance with the reward data in the event definition data selected.

As a result, in some embodiments, the selection operation of the event definition data is accepted as the gathering request operation and the gathering event that gathers the participating user at the gathering place can be started. The success/failure determination of the gathering event can be performed in accordance with the gathering condition data, and the reward can be given to the directing user and/or the participating user in accordance with the reward data.

According to a twenty-seventh aspect of the present disclosure, the map image display control in the computer system may include, on the terminal of the participating user,

displaying a view image based on a current user position of the participating user in a switchable manner with the map image, and displaying a direction display body indicating a direction of the gathering place in the view image.

As a result, in some embodiments, the view image based on the user position of the participating user can be displayed on the terminal of the participating user. In addition, the direction of the gathering place can be displayed in the view image so as to show the direction that the participating user should go.

According to a twenty-eighth aspect of the present disclosure, the start control in the computer system may include accepting the gathering request operation from a user who satisfies a predetermined gathering request operation permitting condition as the directing user.

As a result, in some embodiments, the directing user entitled to perform the gathering request operation can be limited to the user who satisfies the gathering request operation permitting condition.

According to a twenty-ninth aspect of the present disclosure, the start control in the computer system may include controlling the start of the gathering event with a user who has a predetermined relationship with the directing user as the participating user.

As a result, in some embodiments, the participating user in the gathering event can be limited to the user in the predetermined relationship with the directing user.

According to a thirtieth aspect of the present disclosure, a system may comprise: the computer system described above; and a user terminal configured to be able to communicate with the computer system.

As a result, in some embodiments, the system including the computer system described above can be implemented.

Exemplary embodiments are described below. Note that the following exemplary embodiments do not in any way limit the scope of the content defined by the claims laid out herein. Note also that all of the elements described in the present embodiment should not necessarily be taken as essential elements

Preferred embodiments of the present disclosure are hereinafter described referring to the drawings. However, the present disclosure is not limited by the following embodiments, and the modes to which the present disclosure is applicable are not limited to the following embodiments.

[General Configuration]

First, an example of a system configuration common to a first embodiment and a second embodiment is described.

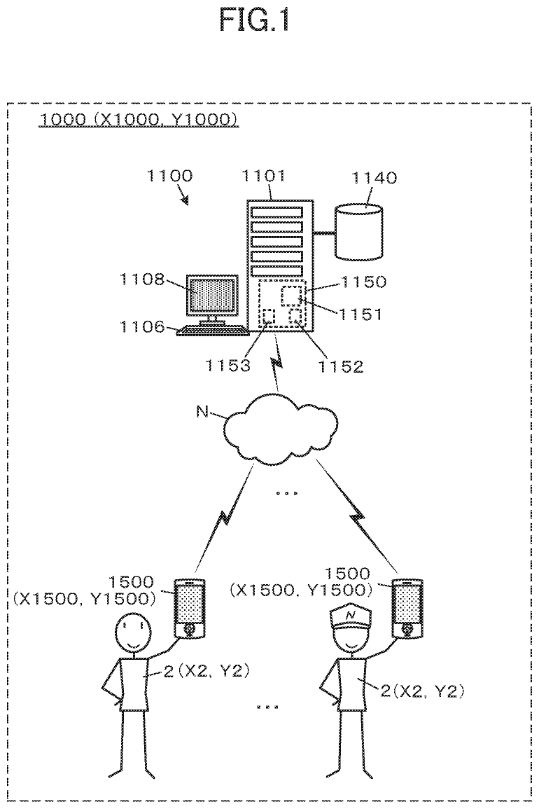

FIG. 1 is a diagram illustrating an example of a general configuration of a game system 1000. The example of the configuration of the game system 1000 in FIG. 1 is common to a game system X1000 according to the first embodiment and a game system Y1000 according to the second embodiment. As illustrated in FIG. 1, the game system 1000 includes a server system 1100 (X1100, Y1100) as a computer system and a user terminal 1500 (X1500, Y1500) possessed by a user who is a player 2 (X2, Y2) playing a game according to the present embodiments. The server system 1100 and the user terminal 1500 are connected to perform data communication with each other via a network N.

The network N is a communication channel that enables data communication. Specifically, the network N includes a communication network such as a local area network (LAN) using a private line (a private cable) for direct connection, Ethernet (registered trademark), or the like, a telecommunication network, a cable network, and the Internet. A communication method may be a cable communication method or a wireless communication method.

The server system 1100 includes a main body device 1101, a keyboard 1106, a touch panel 1108, and a storage 1140. The main body device 1101 includes a control board 1150 on which mounted are electronic components including microprocessors of various types such as a central processing unit (CPU) 1151, a graphics processing unit (GPU), and a digital signal processor (DSP), an IC memory 1152 of various types such as a VRAM, a RAM, and a ROM, and a communication device 1153. The control board 1150 may be entirely or partially implemented by an application specific integrated circuit (ASIC), a field-programmable gate array (FPGA), or a system on a chip (SoC). The example of the configuration of the server system 1100 in FIG. 1 is common in the server system X1100 according to the first embodiment and the server system Y1100 according to the second embodiment.

Through a calculation process performed by the CPU 1151 or the like based on a predetermined program and data, the server system 1100 implements a user management function related to user registration or the like and a game management function of providing data required to play the game with the user terminal 1500 to manage an execution control on the game played with the user terminal 1500. That is, the game according to the present embodiment is implemented as a kind of client-server online game. A user 2 (also called as a “player 2” as appropriate) uses his/her user terminal 1500 to access the server system 1100 and log in with an issued account to play the game according to the present embodiment.

The server system 1100 cooperates with an external electronic settlement server administrated by an electronic payment company or the like to perform a purchase procedure (a charging process) of game coins of in-game currency. In the billing process, the electronic settlement server settles a purchase amount of the game coins with a credit card, a prepaid card, or the like of the player 2 in response to an inquiry from the server system 1100. Then, the server system 1100 provides the player 2 with the game coins corresponding to the purchase amount settled by the electronic settlement server.

The server system 1100 is not limited to a single server configuration illustrated in FIG. 1, and may be configured such that a plurality of blade servers sharing the functions are connected via an internal bus to perform data communication. Alternatively, the server system 1100 may be configured such that a plurality of independent servers installed at separate places perform data communication via the network N to serve as the server system 1100 as a whole.

The user terminal 1500 (X1500, Y1500) is a computer system that functions as a man-machine interface, and connects to the network N via a mobile phone base station, a wireless communication base station, or the like to perform data communication with the server system 1100. The user terminal 1500 may be implemented as, for example, a smartphone, a mobile phone, a portable game device, a stationary consumer game device, a controller of the stationary consumer game device, an arcade game apparatus, a personal computer, a tablet computer, or a wearable computer.

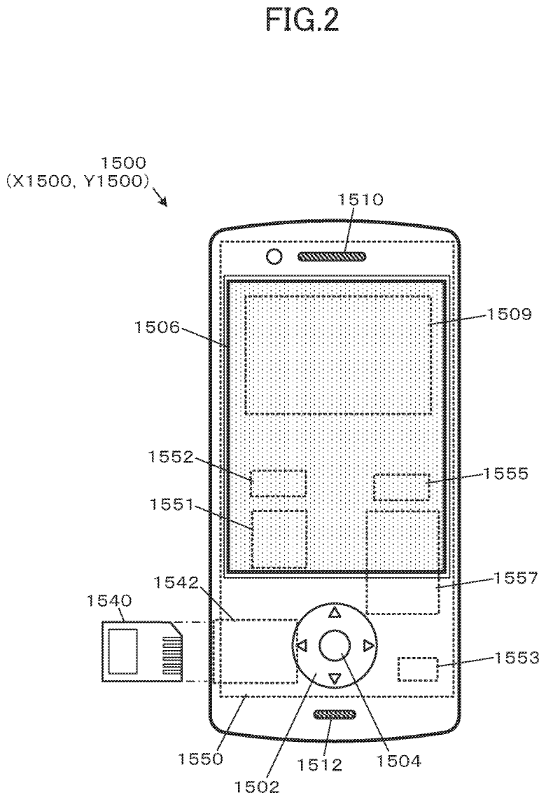

FIG. 2 is a diagram illustrating an example of a device configuration of a smartphone serving as the user terminal 1500. The example of the configuration of the user terminal 1500 in FIG. 2 is common in the user terminal X1500 according to the first embodiment and the user terminal Y1500 according to the second embodiment. As illustrated in FIG. 2, the user terminal 1500 includes an arrow key 1502, a home key 1504, a touch panel 1506 that functions as an image display device and a touch position input device, a built-in battery 1509, a speaker 1510, a microphone 1512, a control board 1550, and a memory card reader 1542 that can write and read data on and from a memory card 1540 that is a computer readable storage medium. The user terminal 1500 further includes a power button, a volume control button, and the like (not illustrated).

The control board 1550 includes, for example, microprocessors of various types such as a CPU 1551, a GPU, and a DSP, an IC memory 1552 of various types such as a VRAM, a RAM, or a ROM, a wireless communication module 1553 for performing wireless communication with a mobile phone base station, a wireless LAN base station, or the like connected to the network N, a positioning module 1555, an interface circuit 1557, and the like. The interface circuit 1557 includes a circuit that receives signals from the arrow key 1502 and the home key 1504, a driver circuit for the touch panel 1506, an output amplifier circuit that outputs sound signals to the speaker 1510, an audio signal generation circuit that generates signals corresponding to sounds collected by the microphone 1512, and a signal input-output circuit for the memory card reader 1542. These elements included in the control board 1550 are electrically connected through a bus circuit or the like so that the elements can read and write data and exchange signals. The control board 1550 may be partially or entirely implemented by the ASIC, the FPGA, or the SoC.

The IC memory 1552 on the control board 1550 stores, for example, a game client program and various types of setting data required to execute the game client program. The game client program or the like is downloaded from the server system 1100 at appropriate timing. Alternatively, the game client program or the like may be read out from a storage medium such as the memory card 1540 separately provided. The CPU 1551 or the like executes the game client program to perform a calculation process, and controls each section of the user terminal 1500 to enable gameplay of the player 2 in accordance with an operation input with the touch panel 1506, the arrow key 1502, and the home key 1504.

The positioning module 1555 is a means for acquiring a position of the user. According to the present embodiment, the positioning module 1555 uses a known positioning system to acquire position coordinates and a direction in the real space. That is, the positioning module 1555 receives signals provided from the positioning system and outputs positioning information in a predetermined cycle (e.g., at every second) so as to provide a positioning function to the user terminal 1500. The positioning system may be Global Navigation Satellite System (GNSS) that is a satellite positioning system represented by Global Positioning System (GPS), for example. In such a case, the positioning module 1555 can be implemented by a known GPS module, a known GPS receiver, or the like. Galileo or BeiDou Navigation Satellite System (BDS) may be used in place of GPS. A system for positioning by trilateration based on communication among a plurality of communication base stations and a mobile station, or an RTK positioning system using GNSS and base station communication may also be used. The positioning information includes a measurement date and time (coordinated universal time [UTC]), position coordinates (latitude/longitude/altitude), a direction or the like. The position coordinates obtained by the positioning module 1555, i.e., a position of the user terminal 1500, are referred to as a “user position”.

The positioning module 1555 may be replaced with a configuration including a communication device performing wireless communication with a wireless base station of a mobile phone or a Wi-Fi network and a direction sensor. That is, as a replacement, so-called simplified position information may be acquired by acquiring pre-measured position information of the wireless base station to which the user terminal is connected, and considering this position information as the position coordinates of the user terminal in the real space. Then, the direction that the user terminal faces in the real space may be acquired by the direction sensor.

### First Embodiment

Next, the first embodiment is described.

The first embodiment is described based on an example case where a plurality of users (players) play a game by operating user characters (player characters) in a game space of a virtual space that the plurality of users share, or use to play together. The first embodiment can be applied not only to the game, but also to various types of content where the plurality of users can operate the user characters during the progress of the content.

[Game According to First Embodiment]

The game according to the first embodiment has a game space of a so-called open-world type, and is an RPG game that an encounter between a player character and an enemy character executes a battle (a match). The enemy character is a non-playable character (NPC) controlled by a computer. The game according to the first embodiment has the game space shared by the plurality of players. The plurality of players are divided into teams by a matching process when participating in the game. The match executed by the encounter may occur between the player characters on different teams.

The server system X1100 accepts a gathering request operation from a directing player serving as a directing user, and executes a gathering event that gathers the player characters of participating players serving as participating users at a given gathering place in the game space during the game.

According to the first embodiment, a player who is set as a team leader beforehand becomes the directing player, and only the player serving as the team leader performs the gathering request operation with an execution right for the gathering event. In response to the gathering request operation, members assigned, or matched, in the matching process, to the same team as the team leader who has performed the gathering request operation become the participating players in the gathering event. Alternatively, a member other than the team leader may perform the gathering request operation as the directing player. In addition, reaching a predetermined player level may be a condition for becoming the directing player.

Furthermore, according to the first embodiment, a plurality of types of event execution items are prepared as items available for the players during the gameplay. Use of any one of the plurality of types of event execution items by the directing player is accepted as the gathering request operation. An acquisition condition of the event execution item may be set as appropriate. For example, the event execution item can be acquired as a reward for clearing a game stage, from a treasure chest in a game stage, as a dropped object dropped by defeating an enemy character appeared. In addition, the event execution item can be acquired as a login bonus, prizes of various events, or by a lottery called gacha. The event execution item can also be acquired or purchased in exchange for spending of points of a predetermined amount. The points may be points provided to the players during the gameplay, or may be game coins (in-game currency) provided through a purchase procedure (a charging process) by the players. In addition, the event execution item can be acquired by satisfying an acquisition condition that the user executes another game, visits an advertisement web page, or the like.

According to the first embodiment, each of the event execution items is set with event definition data defining content of the gathering event, and the server system X1100 executes the gathering event based on the event definition data. As for a procedure, the server system X1100 first controls a start of the gathering event based on the event definition data of the event execution item used (event start control process). Then, the server system X1100 also controls a display of a game image displaying a gathering place in the game space in an identifiable display mode on the user terminals X1500 of the directing player and each participating player (game image display control process). Then, the server system X1100 performs an event success/failure determination of the gathering event using a position of the player character operated by each of the participating players at appropriate timing (event success/failure determination process). According to the first embodiment, the participating player is required to satisfy a prerequisite condition requiring that the player character of the participating player gather at the gathering place by a gathering time. In addition, the participating player is further required that action of the player character before the gathering satisfy a fulfillment condition. The server system X1100 determines the success/failure of the gathering event based on the number of participating players who have received an affirmative determination in an individual determination of fulfillment of these conditions. Consequently, the server system X1100 gives the directing player and/or the participating player a given reward when the server system X1100 determines that the gathering event is a success in the event success/failure determination (reward giving process).

1. Event Definition Data

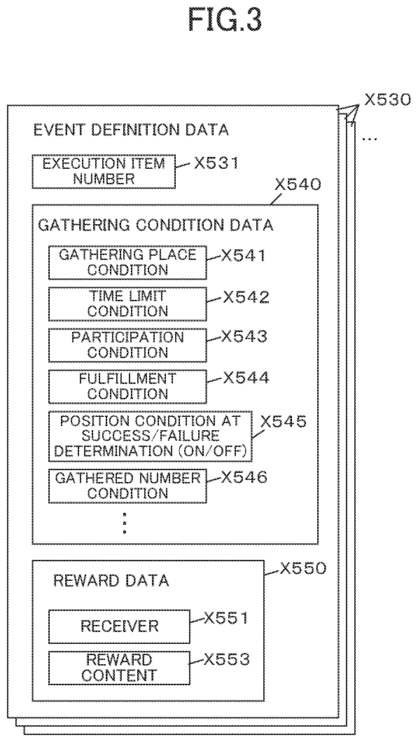

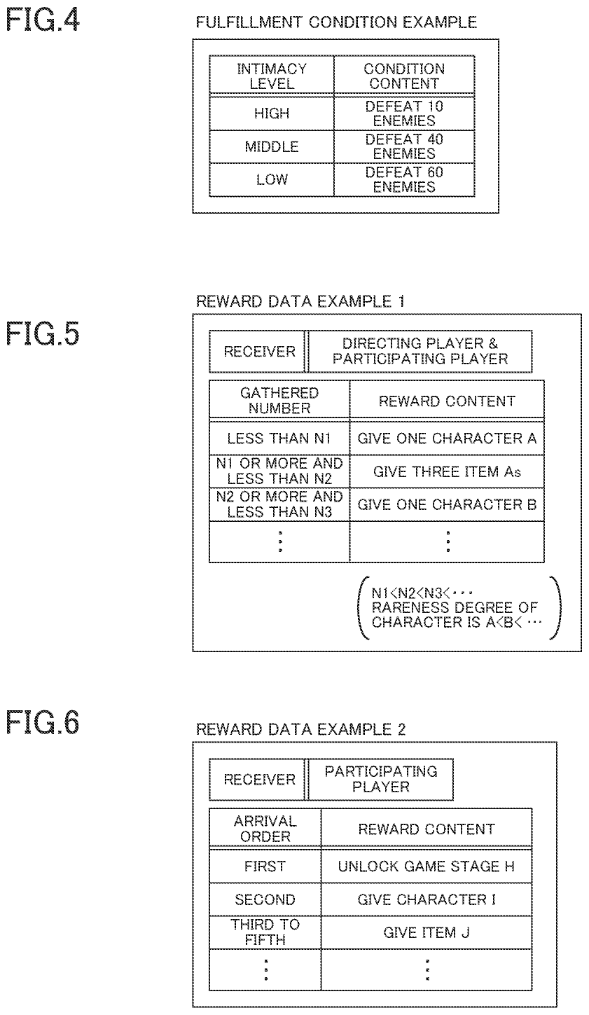

FIG. 3 is a diagram illustrating an example of a data configuration of the event definition data X530. As illustrated in FIG. 3, one piece of event definition data X530 includes an execution item number X531, gathering condition data X540, and reward data X550. The gathering condition data X540 includes a gathering place condition X541, a time limit condition X542, a participation condition X543, a fulfillment condition X544, a position condition X545 at a success/failure determination, and a gathered number condition X546. The reward data X550 includes a receiver X551 and reward content X553 of the reward in relation to the gathering event. FIG. 4 illustrates an example of the fulfillment condition X544, and FIGS. 5 and 6 illustrate examples of the reward data X550.

The gathering place condition X541 specifies a position of the gathering place in the game space in the gathering event.

The time limit condition X542 specifies a limited time period for the gathering event. According to the first embodiment, the gathering time of the gathering event is set in accordance with the time limit condition X542. That is, the server system X1100 sets the gathering time to the time when an elapsed time period from a start time (when the event execution item is used) reaches the specified limited time period in the event start control of the gathering event. The time may be consistent with the time in a real world, or may be the time in a game world.

The participation condition X543 specifies participating players in the gathering event. For example, the participation condition X543 can specify all the members in the team other than the team leader as the participating players, or all the members in the team including the team leader serving as the directing player as the participating players. In the former case, the team leader serving as the directing player does not need to move his/her player character to the gathering place. In the latter case, since the directing player is also the participating player, the team leader starts the gathering event by the gathering request operation and participates in the gathering event that he/she has started to successfully accomplish the gathering event. In addition, the participation condition X543 can also include a setting requiring that the player level have reached a predetermined level, that the player have spent the points of a predetermined amount, or the like, or a combination thereof. In such a case, the members who satisfy the condition are set as the participating players. Alternatively, the participation condition X543 may include a condition that specifies specific members as the participating players. For example, the participation condition X543 can include a setting requiring that the player is appointed by the directing player. In such a case, the server system separately accepts an appointing operation from the directing player to set the participating players.

The fulfillment condition X544 is a condition relating to the action of the player character of each participating player in the game space before the player character gathers at the gathering place. For example, the fulfillment condition X544 can be a condition that specifies a type and the number of enemy characters to defeat, a place to visit in the game space, an item to acquire, a game stage to clear before the player character gathers at the gathering place, or the like, or a combination thereof. Accordingly, the participating player needs to operate his/her player character to satisfy the fulfillment condition X544 during the gathering event, and then to move to the gathering place by the gathering time.

More specifically, the fulfillment condition X544 includes settings having different degrees of difficulty corresponding to intimacy levels of the participating player with respect to the directing player. For example, when the fulfillment condition for each intimacy level is the number of enemy characters to defeat, the number is set to decrease as the intimacy level rises. When the fulfillment condition for each intimacy level is an item to acquire, a type of item having lower difficulty in acquiring is set as the intimacy level rises. Accordingly, the fulfillment condition that is easier to accomplish can be set for the participating player having higher intimacy with respect to the directing player. For example, in the example in FIG. 4, the intimacy levels include three stages of high, middle, and low, and are respectively set with the fulfillment conditions each specifying a different number of enemy characters to defeat.

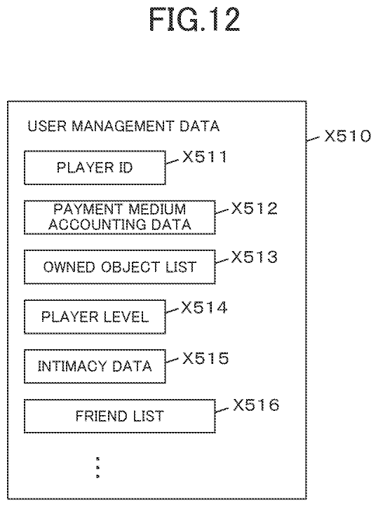

The intimacy levels used here indicate differences in intimacy index values between the directing player and the participating player. The intimacy index value is an index value indicating the intimacy between the players, and the server system X1100 manages for each player the intimacy index values with respect to other players (intimacy data X515 in FIG. 12). In particular, the server system X1100, for each player with respect to all other players, updates and manages the intimacy index value between the player and another player at any time based on the number of times or a frequency of playing the game together, the number of times or a frequency of chat during the gameplay, the number of times or a frequency of giving and/or receiving game objects, or the like. Accordingly, if the player repeatedly makes a team with a specific player to play the game or frequently chats with the specific player, the intimacy index value between the player and the specific player rises.

The stages of the intimacy level are not limited to the three stages of high, middle, and low, described above, and may include two, four, or more stages. Instead of the intimacy index value, enrollment in a friend registration may be used. For example, the content of the fulfillment condition X544 with the enrollment in the friend registration can be set to have a lower degree of difficulty than the degree of difficulty set for the fulfillment condition X544 without the enrollment in the friend registration so that the participating player enrolled in the friend registration of the directing player can fulfill the fulfillment condition easily.

The position condition X545 at the success/failure determination is flag information that is used for the determination of fulfillment of the prerequisite condition of whether the player character gathered at the gathering place by the gathering time. The flag information indicates whether the player character is required to be at the gathering place at the gathering time (ON in this case, for example), or the player is required only to move to the gathering place by the gathering time after the start of the gathering event without restriction on the position at the gathering time (OFF in this case, for example).

The gathered number condition X546 is a condition used for determining that the gathering event is a success in the event success/failure determination, and specifies the number of participating players who have received an affirmative determination in the individual determination. For example, for the success of the gathering event including the gathered number condition X546 set to all, all the participating players need to receive the affirmative determination in the individual determination. On the other hand, when the gathered number condition X546 is set to one, the gathering event is determined to be a success if any one of the participating players has received the affirmative determination in the individual determination.

The receiver X551 in the reward data X550 specifies the player who receives the reward set in the reward content. According to the first embodiment, the receiver X551 is set to the directing player and/or the participating player.

The reward content X553 specifies the content of the reward to be given when the gathering event is determined to be a success in the event success/failure determination. For example, the reward content is set to giving a game object such as a character or an item as the reward. Alternatively, the reward may be unlocking a new game stage or a map. Alternatively, the reward may be execution of various game events such as execution of a mini game. The game object includes a character selectable as a player character, various types of items that a player character can possess or use such as a weapon, a protection, a bullet, or medicine, a vehicle of a player character, a summoned beast, an additional ability that can be added to a player character such as magic or a skill, a right of lottery (a lottery ticket) for getting a character or an item by lottery, or the like. When the receiver X551 is set to both the directing player and the participating player, the setting of the reward content X553 may be the same for both the directing player and the participating player, or may be different.

More specifically, when the gathered number condition X546 for the gathering event is set to a lower limit value such as one or more, as illustrated in FIG. 5, for example, the different reward content corresponding to the gathered number is set such that a rareness degree of a game object to be given becomes higher or the number of game objects to be given becomes larger as the actual gathered number becomes larger. Furthermore, as illustrated in FIG. 6, the different reward content may be set correspondingly to an order of arrival time (an order of arrival) at the gathering place. In addition, the reward content can include a setting to give a reward for the participation to players who have received a negative determination in the individual determination among the participating players.

According to the first embodiment, the team leader becomes the directing player, as described above. However, besides the player of the team leader, any player who has acquired the event execution item may become the directing player to execute the gathering event by using the event execution item at any timing. Alternatively, the gathering condition data in the event definition data X530 may include a directing condition that specifies the directing player of the gathering event. For example, the directing condition may include a setting requiring that the player be the team leader, that the player level of the player have reached a predetermined level, that the player have spent the points of a predetermined amount, or the like, or a combination thereof.

2. Event Start Control Process

In the event start control process, the operation to use the event execution item by the team leader is accepted as the gathering request operation. Then, the gathering place is set based on the gathering place condition X541 of the event execution item used, the gathering time is set based on the time limit condition X542, the participating players are set based on the participation condition X543, and the fulfillment condition is set based on the fulfillment condition X544 so as to control the start of the gathering event.

3. Game Image Display Control Process

A map image of a bird's eye view of the game space and a view image of a first-person view or a third-person view of the player character operated by the player are displayed on the user terminal X1500 of each player in a switchable manner as a game image during the game. In the game image display control process, the display of the map image and the view image is controlled in the first place. The map image may be displayed on the view image all the time.

3-1. Map Image

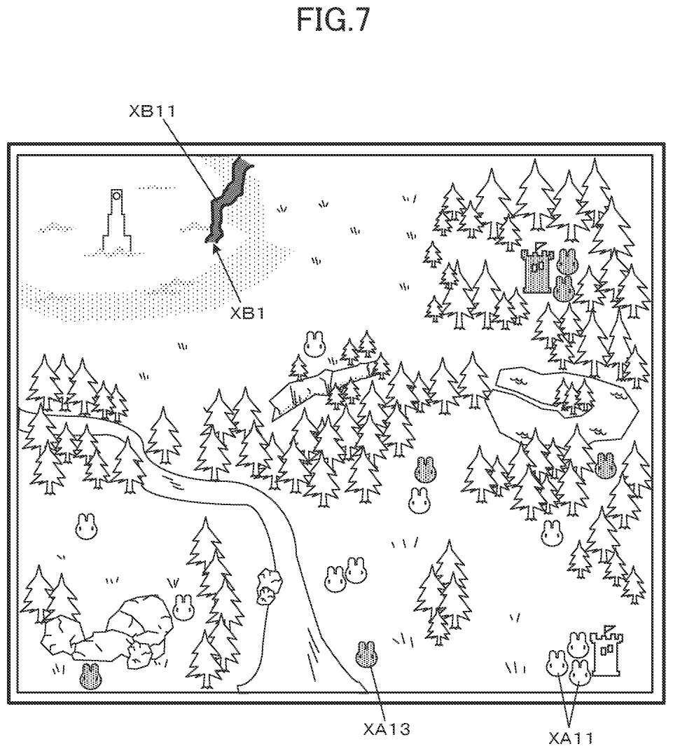

FIG. 7 is a diagram illustrating an example of the map image. The map image includes a map showing geometrical features of the game space and an arrangement of major buildings or the like, and markers XA11 and XA13 indicating positions of the player character and the enemy character displayed on the map as appropriate. The map image can be used to understand positional relationships with respect to the player characters in the same team and the enemy characters, and to understand a positional relationship with respect to a destination.

FIG. 7 illustrates a map screen during the gathering event. In the game image display control process, a control for displaying a gathering place XB1 in the identifiable display mode on the map image during the gathering event is performed in the second place. In the example in FIG. 7, the gathering place XB1 is displayed in the identifiable manner by a display of a signal fire XB11 rising from the gathering place XB1.

Furthermore, in the game image display control process, a control for displaying various event detail items of the gathering event is performed in association with the display of the gathering place XB1 in the third place. The display control of the event detail items is performed in response to a touch operation in the vicinity of the gathering place XB1 on the user terminal X1500, for example. When the operation on the user terminal X1500 of the participating player is detected, a detail screen for a participant is displayed on the map image.

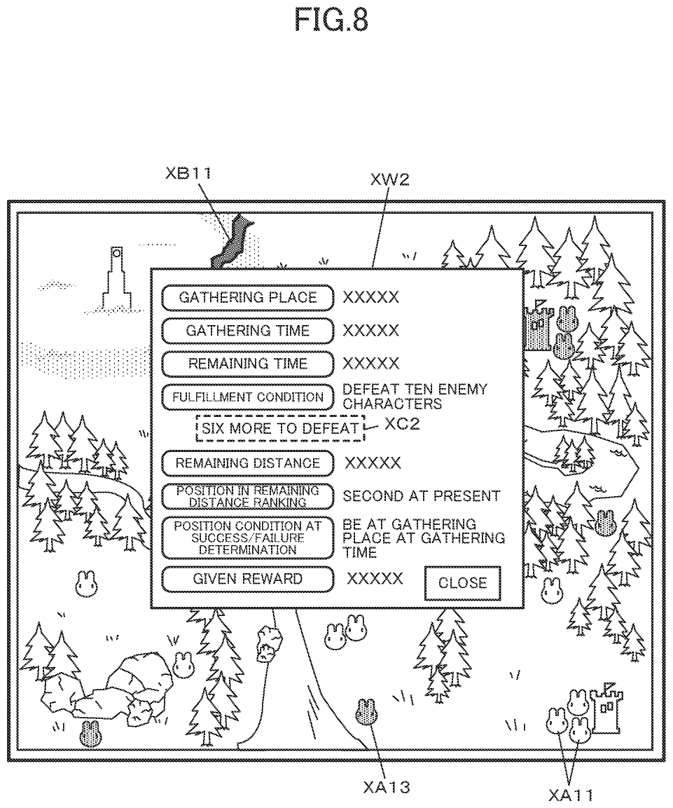

FIG. 8 is a diagram illustrating a display example of a detail screen XW2 for the participant. As illustrated in FIG. 8, the event detail items displayed in the detail screen XW2 for the participant include a gathering place, a gathering time, a remaining time, a fulfillment condition, a fulfilled status of the fulfillment condition, a remaining distance, a position in a remaining distance ranking, a position condition at a success/failure determination, and a given reward of the gathering event. Only some of these event detail items may be displayed.

The fulfilled status of the fulfillment condition indicates how much the player (the participating player using the user terminal X1500) has fulfilled the fulfillment condition at the point when the detail screen XW2 for the participant is displayed. This corresponds to a display XC2 shown by a broken line in FIG. 8. The remaining distance is a distance to the gathering place from the player character of the player. The position in the remaining distance ranking indicates the position of the player in the ranking of the remaining distance of each participating player. According to the first embodiment, the ranking ranks the remaining distance of each participating player in order from shortest. In the example in FIG. 8, the player can see that the player character of the player is at a second closest position to the gathering place among the participating players. The given reward indicates the reward that the participating player can acquire in the gathering event.

With the display of the detail screen XW2 for the participant, the participating player can work toward successfully accomplishing the gathering event while knowing the gathering time (remaining time), the actions that the player character needs to take by then, or the like during the gathering event, for example.

Furthermore, in the game image display control process, a control for displaying a gathering status of each participating player is performed based on the remaining distance of the participating player in the gathering event in association with the display of the gathering place XB1 in the fourth place. The display control of the gathering status is performed in response to a touch operation in a vicinity of the gathering place XB1 on the user terminal X1500, for example. When the operation on the user terminal X1500 of the directing player is detected, a detail screen for a director is displayed on the map image.

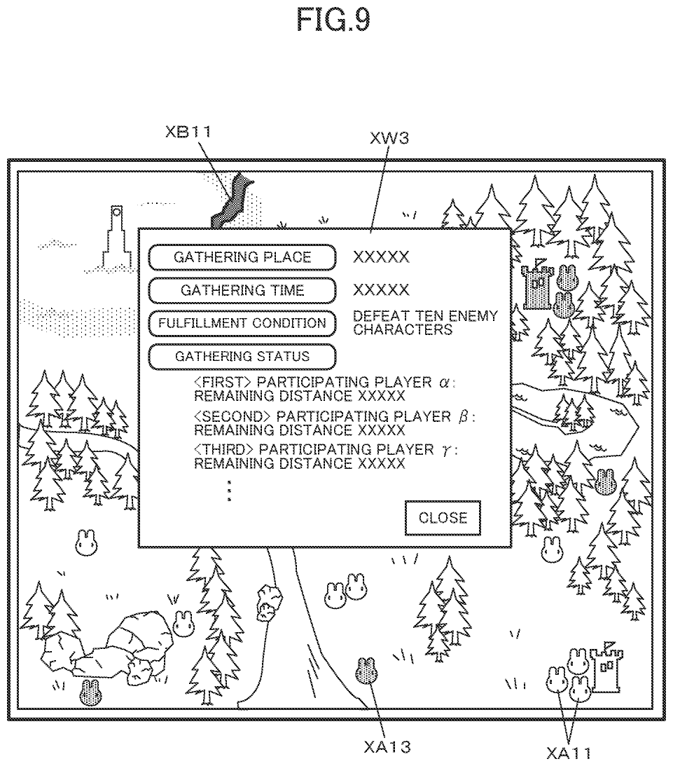

FIG. 9 is a diagram illustrating an example of a detail screen XW3 for the director. As illustrated in FIG. 9, the detail screen XW3 for the director displays a gathering place, a gathering time, a fulfillment condition, and a gathering status of the gathering event, for example.

The gathering status displays the remaining distance of each participating player at the point when the detail screen XW3 for the director is displayed. In FIG. 9, the remaining distance of each participating player is displayed in order of the remaining distance ranking. The fulfilled status of the fulfillment condition of each participating player may be displayed together with the remaining distance. Furthermore, a required time that the player character of the participating player requires to move to the gathering place may be calculated from the remaining distance for each participating player to be displayed together with the remaining distance. Alternatively, the required time may be displayed instead of the remaining distance.

With the display of the detail screen XW3 for the director, the directing player can see whether each of the participating players is approaching the gathering place during the gathering event. The content (the item of the gathering status) of the detail screen XW3 for the director may also be displayed on the user terminal X1500 of each participating user so that the participating user can see the content.

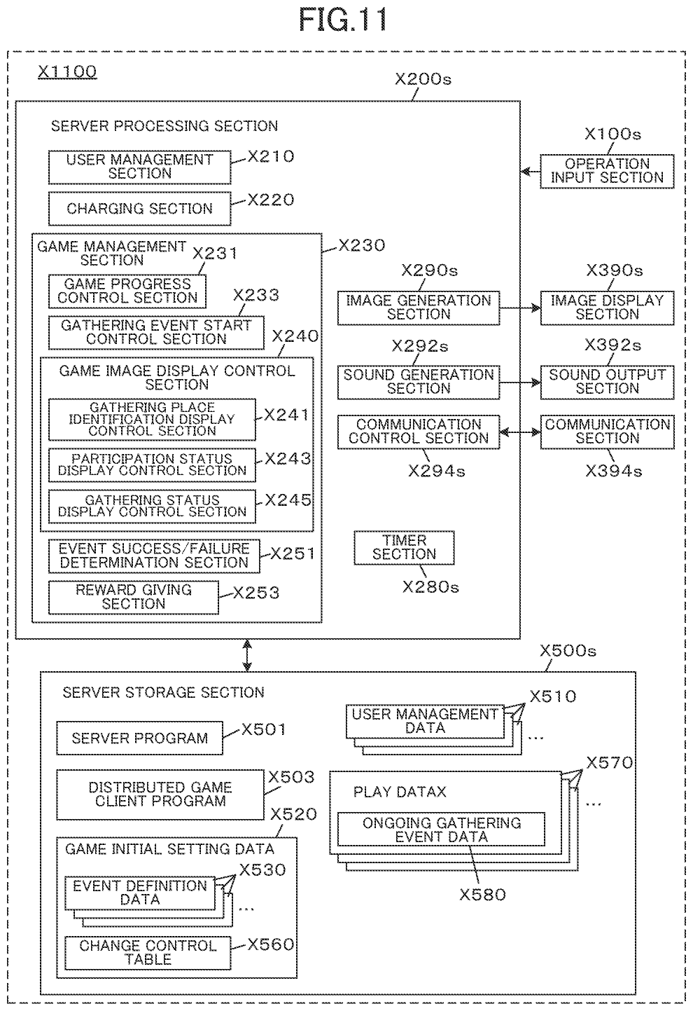

Furthermore, in the game image display control process, a control for changing a display mode of the gathering place XB1 in the map image during the gathering event is performed in accordance with the remaining time to the gathering time in the fifth place. According to the first embodiment, a change control is performed by changing the display mode of the signal fire XB11 indicating the gathering place XB1 in the identifiable manner. For that purpose, for example, a change control table X560 (see FIG. 11) defining a correspondence relation between a length of the remaining time and the display mode of the signal fire XB11 is prepared beforehand. For example, display color is set to differ for each length of time. More distinct color is preferably set for a shorter length of time. Alternatively, a shape or size of the signal fire XB11 may be set to differ for each length of time, or the display mode for each length of time may be defined by a combination of these elements. Then, the change control of the display mode is performed by controlling the display of the signal fire XB11 in accordance with the setting of the display mode corresponding to the actual remaining time for each user terminal X1500 of the directing player and the participating player. As a result, the participating player can visually recognize that the remaining time becomes short from the display mode of the gathering place XB1 on the map image.

The change control of the display mode may be performed only to the user terminal X1500 of the participating player, and not to the user terminal X1500 of the directing player.

Furthermore, the display mode of the gathering place XB1 may be changed in accordance with the remaining distance of the participating player. This control can be performed instead of the change control relating to the remaining time described above, or both may be performed. In such a case, for example, the correspondence relation between the remaining distance and the display mode of the signal fire XB11 is defined beforehand. Then, the display of the signal fire XB11 is controlled in accordance with the display mode corresponding to the actual remaining distance of the participating player using the user terminal X1500 for each user terminal X1500 of at least the participating player. As a result, the participating player can visually recognize that he/she is near the gathering place from the display mode of the gathering place XB1 on the map image.

Alternatively, in addition to the remaining distance of the participating player using the user terminal X1500, the remaining distances of other participating players may also be used to change the display mode. For example, a correspondence relation between the number of participating players approaching the gathering place XB1 and the display mode of the signal fire XB11 is defined beforehand. Then, the participating players whose remaining distances are actually equal to or shorter than a predetermined threshold value are determined to be approaching the gathering place XB1, and the display of the signal fire XB11 is controlled in accordance with the display mode corresponding to the number of participating players approaching the gathering place XB1. As a result, the participating player and/or the directing player can visually recognize whether the number of participating players close to the gathering place is large or not from the display mode of the gathering place XB1 on the map image.

3-2. View Image

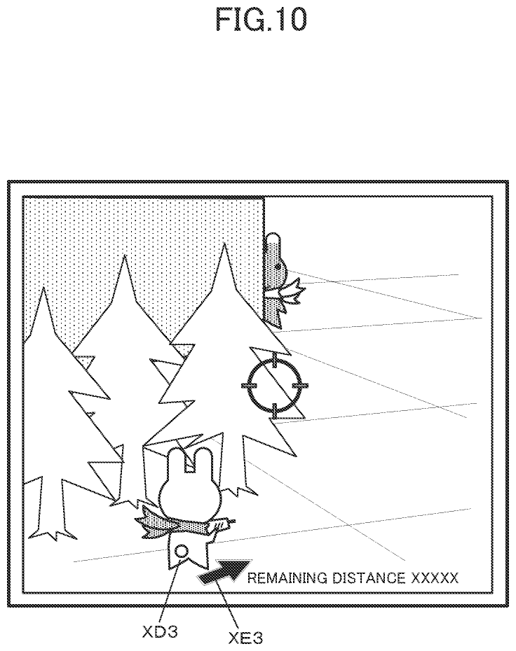

FIG. 10 is a diagram illustrating an example of the view image displayed on the user terminal X1500 of the participating player during the gathering event. As illustrated in FIG. 10, in the game image for the participating player during the gathering event, a direction display body XE3 indicating a direction of the gathering place by a direction of an arrow is displayed near the player character XD3 operated by the participating player. The direction display body XE3 is accompanied with a display of the remaining distance to the gathering place. In addition to the remaining distance, another event detail item such as the position in the remaining distance ranking or the fulfilled status of the fulfillment condition, the required time described above, or the like can be displayed as appropriate.

4. Event Success/Failure Determination Process

According to the first embodiment, the event success/failure determination process is performed at the gathering time, and the individual determination is performed for each participating player at first. That is, when the gathering time comes, it is determined whether the prerequisite condition is satisfied from the position of the player character of the participating player during the gathering event or the position of the player character at the gathering time in accordance with the position condition at the success/failure determination. Then, when the prerequisite condition is satisfied, it is determined whether the actions of the player character before the player character gathers at the gathering place satisfy the fulfillment condition for the participating player. When it is determined that the fulfillment condition is satisfied, the participating player is given the affirmative determination in the individual determination. Then, it is determined whether the number of participating players who have received the affirmative determination in the individual determination satisfies the gathered number condition. When the number satisfies the condition, the gathering event is determined to be a success, and when the number does not satisfy the condition, the gathering event is determined to be a failure.

5. Reward Giving Process

In the reward giving process, the reward of the reward content is given to the player of the receiver (the directing player and/or the participating player) in accordance with the reward data of the gathering event when the gathering event is determined to be a success in the event success/failure determination.

[Functional Configuration]

1. Server System

FIG. 11 is a block diagram illustrating an example of a functional configuration of the server system X1100. As illustrated in FIG. 11, the server system X1100 according to the first embodiment includes an operation input section X100s, a server processing section X200s, an image display section X390s, a sound output section X392s, a communication section X394s, and a server storage section X500s.

The operation input section X100s is a means for inputting various operations for system management and maintenance, and can be implemented by, for example, a keyboard, a mouse, or a touch panel. The operation input section X100s corresponds to the keyboard 1106 and the touch panel 1108 in FIG. 1.

The server processing section X200s can be implemented, for example, by a processor including an arithmetic circuit such as a CPU, a GPU, an ASIC, or an FPGA, and an electronic component such as an IC memory. The server processing section X200s controls input/output of data between device sections including the operation input section X100s and the server storage section X500s. The server processing section X200s performs various calculation processes based on a predetermined program, data, an operation input signal from the operation input section X100s, data received from the user terminal X1500, and the like to integrally control the operation of the server system X1100. The server processing section X200s corresponds to the control board 1150 and the CPU 1151 thereon in FIG. 1.

The server processing section X200s includes a user management section X210, a charging section X220, a game management section X230, a timer section X280s, an image generation section X290s, a sound generation section X292s, and a communication control section X294s.

The user management section X210 performs a process related to user registration and manages the data of each registered user (player) associated with a user account. For example, the user management section X210 can perform an issuing process of issuing a unique account to the registered user, a registration information management process of registering and managing personal information for each account, and a use history management process of managing a history of login and logout or the like. Of course, any other management processes for other data associated with the user account can be included as appropriate.

The billing section X220 performs the charging process in response to the purchase operation of the game coins (in-game currency) by the player, and provides the player with the game coins of the purchase amount.

The game management section X230 performs various processes related to game execution management. According to the first embodiment, a multi-play game is implemented as a client-server online game. Thus, the game management section X230 communicates with the user terminal X1500 to perform a control to provide data required for gameplay. In order to provide the data, the game management section X230 can perform processes in relation to a game progress control and a reflection of a play result including: 1) a process for forming a game space by arranging background objects or the like; 2) a matching process for dividing players participating in the game into predetermined teams (e.g., a red team and a blue team); 3) a process for setting a team leader of each team; 4) a process for disposing a player character in the game space and controlling actions of the player character in accordance with the operation input through the user terminal X1500; 5) a process for disposing and controlling a virtual camera in the game space for each player playing the game; 6) a process for disposing an enemy character in the game space and automatically controlling movements of the enemy character; 7) a process for determining and reflecting a hit and damage of an attack; 8) a process for generating an image (a view image) of the game space as seen from the virtual camera for each player; and 9) a determination process for determining whether a termination condition of the game is satisfied. Accordingly, the game management section X230 can also store various types of data required for controlling the gameplay in the server storage section X500s.

The game management section X230 includes a game progress control section X231, a gathering event start control section X233, a game image display control section X240, an event success/failure determination section X251, and a reward giving section X253.

The game progress control section X231 communicates with the user terminals X1500 of the plurality of players at any time, and controls the game that each player plays by operating his/her player character while watching the game image of the game space that the plurality of players share. According to the first embodiment, the game progress control section X231 controls the progress of the game that the plurality of players play in teams, and performs a reflecting process of play results.

The gathering event start control section X233 is a functional section that performs the gathering event start control process. The gathering event start control section X233 accepts the gathering request operation from the user terminal X1500 of the directing player, and controls the start of the gathering event that gathers the player characters of the participating players at the given gathering place in the game space.

The game image display control section X240 is a functional section that performs the game image display control process, and performs a control for displaying the map image and the view image as the game image on the user terminal X1500 of each player playing the game in response to a switching operation by the player. The game image display control section X240 includes a gathering place identification display control section X241, a participation status display control section X243, and a gathering status display control section X245.

The gathering place identification display control section X241 performs a control for displaying the gathering place of the gathering event in the identifiable display mode when the map image is displayed on the user terminal X1500 of the directing player and the participating player during the gathering event. Furthermore, the gathering place identification display control section X241 performs a control for changing the display mode of the gathering place in accordance with the remaining time to the gathering time. For example, this control corresponds to the display control of the signal fire XB11 in FIG. 7 and the change control of the display mode of the signal fire XB11 corresponding to the remaining time.

The participation status display control section X243 performs a control for displaying the event detail items including the fulfillment condition, the fulfilled status of the fulfillment condition, the remaining distance, the position in the remaining distance ranking, the gathering time, the remaining time to the gathering time on the user terminal X1500 of each participating player in association with the display of the gathering place in the map image. This control corresponds to the display of the detail screen XW2 for the participant (see FIG. 8) on the map image.

The gathering status display control section X245 performs a control for displaying the event detail items including the remaining distance of each participating player on the user terminal X1500 of the directing player in association with the display of the gathering place in the map image. This control corresponds to the display of the detail screen XW3 for the director (see FIG. 9) on the map image.

The event success/failure determination section X251 is a functional section that performs the event success/failure determination process, and performs the event success/failure determination of the gathering event using the position of the player character operated by each participating player.

The reward giving section X253 is a functional section that performs the reward giving process, and gives the given reward to the directing player and/or the participating player when the gathering event is determined to be a success in the event success/failure determination.

The timer section X280s uses a system clock to measure the current date and time, the limited time period, or the like.

The image generation section X290s generates images related to the system management of the server system X1100 or the like, and outputs the resultant to the image display section X390s.

The sound generation section X292s is implemented by execution of an IC or software for generating and decoding sound data, and generates or decodes sound data of operational sounds or BGM related to the system management of the server system X1100 and video distribution, for example. Sound signals related to the system management are output to the sound output section X392s.

The communication control section X294s establishes a communication connection and performs data processing for data communication with an external device (e.g., the user terminal X1500) through the communication section X394s to implement exchange of data with the external device.

The image display section X390s displays various screens for the system management based on the image signals input from the image generation section X290s. For example, the image display section X390s can be implemented by an image display device such as a flat panel display, a projector, or a head-mounted display. The image display section X390s corresponds to the touch panel 1108 in FIG. 1.

The sound output section X392s receives the sound signals input from the sound generation section X292s and emits corresponding sounds. The sound output section X392s corresponds to a speaker (not illustrated) included in the main body device 1101 or the touch panel 1108 in FIG. 1.

The communication section X394s connects to the network N to implement communication. For example, the communication section X394s can be implemented by a wireless communication device, a modem, a terminal adaptor (TA), a jack for wired communication cable, a control circuit, or the like. The communication section X394s corresponds to the communication device 1153 in FIG. 1.

The server storage section X500s stores a program for causing the server system X1100 to operate to implement various functions included in the server system X1100 and data used during execution of the program. The program and the data are stored previously or temporarily at every process. For example, the server storage section X500s can be implemented by an IC memory such as a RAM or a ROM, a magnetic disk such as a hard disk, or an optical disk such as a CD-ROM or a DVD. The server storage section X500s corresponds to the IC memory 1152 and the storage 1140 in FIG. 1.

Furthermore, the server storage section X500s stores a server program X501, a distributed game client program X503, user management data X510, game initial setting data X520, and play data X570. In addition, the server storage section X500s stores necessary data such as a timer, a counter, or various types of flags as appropriate.

The server program X501 is a program for causing the server processing section X200s to function as the user management section X210, the charging section X220, and the game management section X230. The server program X501 may include programs for causing the server processing section X200s to function as the image generation section X290s, the sound generation section X292s, and the communication control section X294s as appropriate.

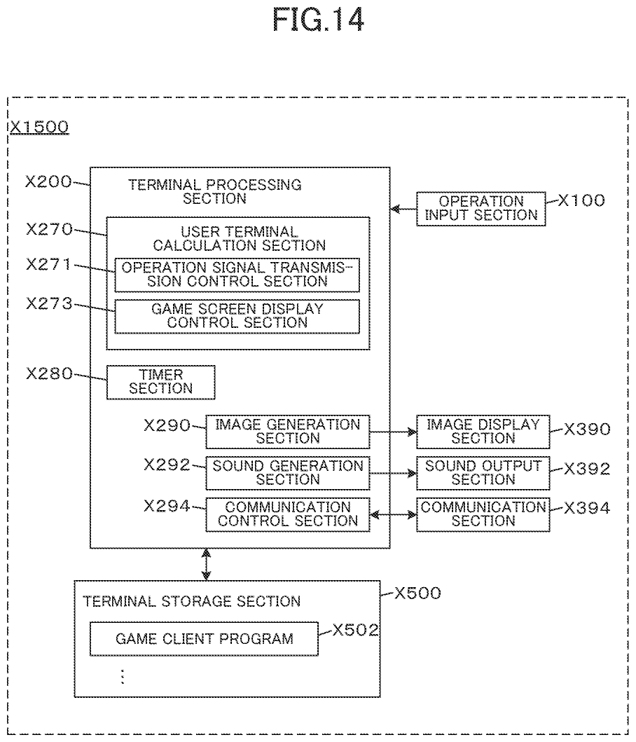

The distributed game client program X503 is an original of a game client program X502 (see FIG. 14) downloaded to the user terminal X1500.

The user management data X510 is prepared for each player who has registered as a user, and includes various types of data for management related to the gameplay of the player. In particular, one piece of user management data X510 includes a player ID (account) X511 of the player, payment medium accounting data X512, an owned object list X513, a player level X514, intimacy data X515, and a friend list X516 as illustrated in FIG. 12. In addition, the user management data X510 may also include a play history such as a play date and time or a play time, saved data related to a progress status of the game, or the like.

The payment medium accounting data X512 includes information on a balance of payment of an electronic payment media (the game coins of the in-game currency in the first embodiment) associated with the player such as a history of date and time of purchase of the game coins and the number of game coins purchased (a charging amount), and a history of date and time of spending of the game coins and the number of game coins spent.

The owned object list X513 includes a list of the game objects such as a character, a weapon, or an item that the player has acquired during the game and owns at the moment. Furthermore, according to the first embodiment, when the game object is given as the reward of the gathering event, an object ID of the game object is added to the owned object list X513.

The intimacy data X515 includes the intimacy index values between the player and other players. The friend list X516 includes accounts of other players enrolled in the friend registration of the player.

Refer back to FIG. 11. The game initial setting data X520 includes initial setting data necessary for executing the game. The game initial setting data X520 includes event definition data X530 and a change control table X560. In addition, the game initial setting data X520 includes player character initial setting data defining a type, initial values of various parameter values, model data, and motion data used for motion control of a character used as the player character, enemy character initial setting data defining a type, various parameter values, and action patterns of an enemy character, object definition data relating to various types of game objects that the player can acquire during the game, stage initial setting data relating to a setting of a game stage, mini game data relating to the execution of the mini game, or the like.

The play data X570 is prepared for each team playing the game, and includes various types of data describing identification information on the players in the team (e.g., player ID X511), a setting of the team leader, and a progress status of the game of the team. The play data X570 includes ongoing gathering event data X580. The ongoing gathering event data X580 is generated by the gathering event start control section X233 at the beginning of the gathering event.

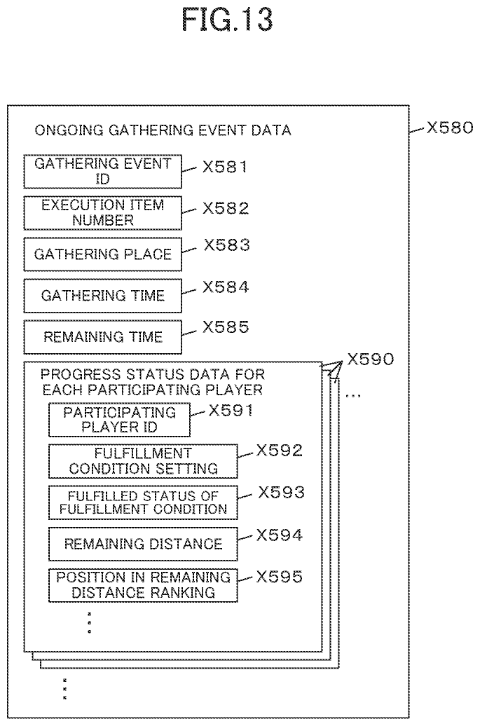

For example, as illustrated in FIG. 13, the ongoing gathering event data X580 includes a gathering event ID X581 for identifying the gathering event, an execution item number X582 of the event execution item relating to the gathering request operation, a gathering place X583 of the gathering event, a gathering time X584, a remaining time X585 to the gathering time, and progress status data X590 for each participating player. The progress status data X590 for each participating player is prepared for each participating player, and includes a player ID X591 of the participating player, a fulfillment condition setting X592 of the participating player, a fulfilled status X593 of the fulfillment condition, a remaining distance X594 to the gathering place X583 from the player character of the participating player, and a position X595 in a remaining distance ranking of the participating player.

2. User Terminal

FIG. 14 is a block diagram illustrating an example of a functional configuration of the user terminal X1500. As illustrated in FIG. 14, the user terminal X1500 includes an operation input section X100, a terminal processing section X200, an image display section X390, a sound output section X392, a communication section X394, and a terminal storage section X500.

The operation input section X100 is used by a player to input various operations, and can be implemented, for example, by a button switch, a joystick, a touch pad, a track ball, an accelerometer, a gyro sensor, or a CCD module. The operation input section X100 corresponds to the arrow key 1502, the home key 1504, and the touch panel 1506 in FIG. 2.

The terminal processing section X200 can be implemented, for example, by a processor including an arithmetic circuit such as a CPU, a GPU, an ASIC, or an FPGA, and an electronic component such as an IC memory. The terminal processing section X200 controls input/output of data between device sections including the operation input section X100 and the terminal storage section X500. The terminal processing section X200 performs various calculation processes based on a predetermined program, data, an operation input signal from the operation input section X100, data received from the server system X1100, and the like to integrally control the operation of the user terminal X1500. The terminal processing section X200 corresponds to the control board 1550 and the CPU 1551 thereon in FIG. 2. The terminal processing section X200 according to the first embodiment includes a user terminal calculation section X270, a timer section X280, an image generation section X290, a sound generation section X292, and a communication control section X294.

The user terminal calculation section X270 performs various calculation processes to cause the user terminal X1500 to function as a terminal for the gameplay of the player. For example, the user terminal calculation section X270 includes an operation signal transmission control section X271, and a game screen display control section X273.

The operation signal transmission control section X271 performs a process of transmitting various types of data and request information to the server system X1100 in accordance with an operation input performed on the operation input section X100.

The game screen display control section X273 performs a control for displaying a game screen based on various types of data received from the server system X1100. For example, when the online game according to the first embodiment is implemented as a web game, the game screen display control section X273 can be implemented by web technology that actively controls the screen display using Java (registered trademark) and cascading style sheets (CSS) along with HTML, with a web browser as a base, and by a plugin such as Adobe (registered trademark) Flash. Other methods may be employed, of course. Furthermore, a game space image serving as a base of the game screen (e.g., 3DCG) is generated in the server system X1100 according to the first embodiment. However, the game space image may be generated in the user terminal X1500. In such a case, the game screen display control section X273 controls an object disposed in a virtual three-dimensional space for generating 3DCG.

The image generation section X290 cooperates with the game screen display control section X273 to generate an image signal for displaying one game screen in every frame time (e.g., 1/60th of a second) based on the various types of data received from the server system X1100, and to output the generated image signal to the image display section X390. For example, the image generation section X290 can be implemented, for example, by a processor such as a GPU or a digital signal processor (DSP), a video signal IC, a program such as a video codec, or a drawing frame IC memory such as a frame buffer.

The sound generation section X292 is implemented, for example, by a processor such as a digital signal processor (DSP) or a sound synthesizing IC, or an audio codec for playing a sound file. The sound generation section X292 generates sound signals for sound effects, BGM, and various types of operational sounds related to the game, and outputs the generated signals to the sound output section X392.

The communication control section X294 establishes a communication connection and performs data processing for data communication with an external device (e.g., the server system X1100) through the communication section X394, and implements exchange of data with the external device.

The image display section X390 displays various screens such as a game screen based on the image signals input from the image generation section X290. For example, the image display section X390 can be implemented by an image display device such as a flat panel display, a projector, or a head-mounted display. The image display section X390 corresponds to the touch panel 1506 in FIG. 2.

The sound output section X392 emits sounds such as sound effects and BGM related to the game, based on the sound signals input from the sound generation section X292. The sound output section X392 corresponds to the speaker 1510 in FIG. 2.

The communication section X394 connects to the network N to implement communication. For example, the communication section X394 can be implemented by a wireless communication device, a modem, a TA, a jack for wired communication cable, a control circuit, or the like. The communication section X394 corresponds to the wireless communication module 1553 in FIG. 2.

The terminal storage section X500 stores a program for causing the user terminal X1500 to operate to implement various functions included in the user terminal X1500 and data used during the execution of the program. The program and the data are stored previously or temporarily at every process. For example, the terminal storage section X500 can be implemented by an IC memory such as a RAM or a ROM, a magnetic disk such as a hard disk, or an optical disk such as a CD-ROM or a DVD. The terminal storage section X500 corresponds to the IC memory 1552 and the memory card 1540 in FIG. 2.

The terminal storage section X500 stores the game client program X502. The game client program X502 is a program for causing the terminal processing section X200 to function as the user terminal calculation section X270. The game client program X502 may be an exclusive client program depending on a technique and a method for implementing an online game or include a web browser program and a plugin that implements an interactive image display. According to the first embodiment, the game client program X502 is a copy of the distributed game client program X503 (see FIG. 11) provided from the server system X1100.

[Flow of Processes]

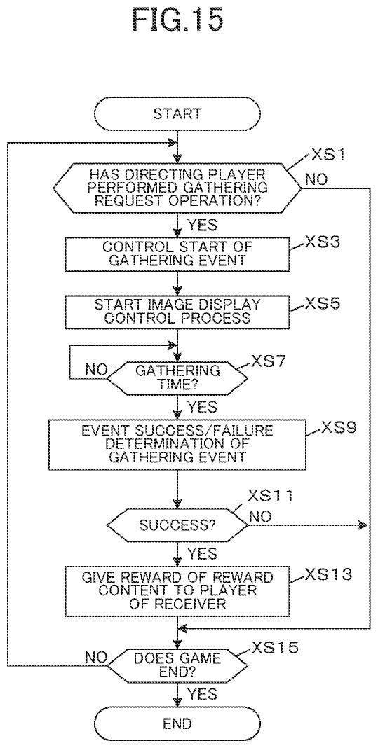

FIG. 15 is a flowchart illustrating a flow of processes relating to the execution of the gathering event in the server system X1100. The processes described herein are implemented by the server processing section X200s reading out and executing the server program X501. FIG. 15 shows a flow of the processes relating to the execution of a single gathering event of a single team.

Firstly, the gathering event start control section X233 accepts the use of the event execution item by the team leader (the directing player) of the team as the gathering request operation. Then, upon detection of the gathering request operation on the user terminal X1500 of the directing player (step XS1: YES), the gathering event start control section X233 sets the gathering place, the gathering time, the participating players, and the fulfillment condition for each participating player based on the event definition data X530 (see FIG. 3) including the execution item number X531 of the event execution item used to generate the ongoing gathering event data X580, and performs the control for starting the gathering event (step XS3).

Then, the game image display control section X240 starts the display control of the game image displaying the gathering place in the game space in the identifiable display mode on the user terminals X1500 of the directing player and the participating player (step XS5). According to the first embodiment, as described referring to FIGS. 7 to 10, the game image display control section X240 performs the display control of the gathering place in the map image in the identifiable manner, the change control of the display mode of the gathering place, the display control of the detail screen W2 for the participant and the detail screen XW3 for the director, and the display control of the direction display body in the view image.

After that, when the gathering time comes (step XS7: YES), the event success/failure determination section X251 performs the event success/failure determination of the gathering event based on the position or the like of the player character of each participating player until the gathering time (step XS9). In particular, the event success/failure determination section X251 performs the individual determination for each participating player based on the gathering place X583, the gathering time X584, and the fulfillment condition X592 of each participating player (see FIG. 13) by using the setting for the position condition X545 at the success/failure determination (see FIG. 3) or the like in the event definition data X530 of the gathering event. Then, the event success/failure determination section X251 determines the success/failure of the gathering event based on the number of participating players who has received the affirmative determination in the individual determination by using the setting for the gathered number condition X546.

When the event success/failure determination section X251 determines that the gathering event is a success in the event success/failure determination (step XS11: YES), the reward giving section X253 gives the reward of the reward content X553 to the player of the receiver X551 in accordance with the reward data X550 of the gathering event (step XS13). For example, when the reward content includes the setting to give a game object, the reward giving section X253 adds the game object to the owned object list X513 of the player of the receiver. Furthermore, when the reward content includes the setting to execute a game event, the reward giving section X253 performs the execution control of the game event.

After that, the flow returns to the step XS1 (step XS15: NO) to repeat the processes described above until the game ends. Then, when the match game ends (step XS15: YES), the flow of the processes is terminated.

As described above, according to the first embodiment, the gathering event that gathers the player characters of the participating players at the given gathering place in the game space can be started in response to the gathering request operation by the directing player during the game that the plurality of players play by operating the player characters. Then, when the gathering event is successfully accomplished, the reward can be given to the directing player and/or the participating players. As a result, a system for executing the gathering event can be provided to the game that each of the plurality of players plays by operating his/her player character in the game space that the plurality of players share, so that new interest can be added to the game.

Modification examples relating to the first embodiment include following modification examples.

### Modification Example 1

According to the first embodiment, the server system X1100 of the client-server game system X1000 is described as an example. However, this should not be construed in a limiting sense. For example, the present disclosure may be implemented by peer-to-peer connection among a plurality of user terminals X1500. In such a case, any of the user terminals X1500 performs the functions of the server system X1100 in the first embodiment. Alternatively, the plurality of user terminals X1500 may share the functions of the game management section X230.

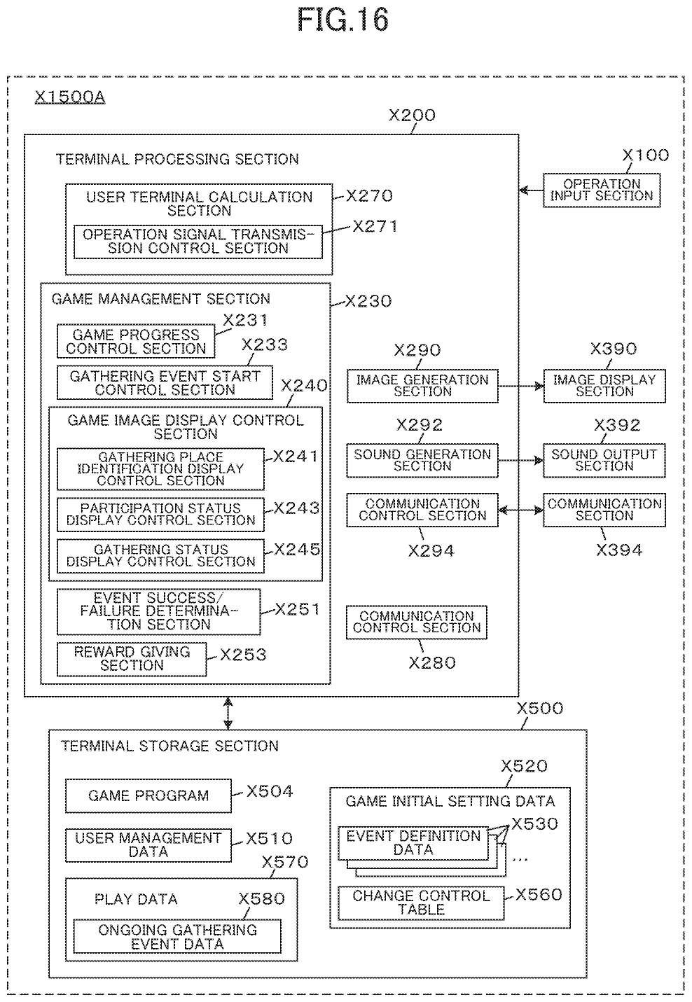

For example, FIG. 16 illustrates an example of a functional configuration of a user terminal X1500A sharing the functions of the server system X1100 in the first embodiment. In FIG. 16, common reference signs are given to components similar to the components in the first embodiment. In this case, the server system X1100 mainly performs user registration and management of registration information, and provides the information in response to a request from the user terminal X1500A.

As illustrated in FIG. 16, in the user terminal 1500A according to the present modification example, the terminal processing section X200 includes the game management section X230, and the game screen display control section X273 is omitted. That is, the user terminal X1500A according to the present modification example does not acquire data for displaying an image of the game screen from the server system X1100, but the game management section X230 of the user terminal X1500A performs the process related to the game management to control the game progress, and generates the image of the game screen. The terminal storage section X500 of this user terminal X1500A stores a game program X504 for causing the terminal processing section X200 to function as the user terminal calculation section X270 and the game management section X230. The terminal storage section 500 also stores the user management data X510 related to the player using the user terminal X1500A, the play data X570 related to the team that the player belongs to, and the game initial setting data X520.

The flow of the processes performed by the user terminal X1500A according to the present modification example is basically the same as the flow in the flowchart in FIG. 15. You may read that the game management section X230 of the user terminal X1500A performs the steps.

According to the present modification example, the same advantageous effects as those in the first embodiment can be obtained. The user terminal X1500A may be partially in charge of the functions of the game management section X230, instead of being entirely in charge of the functions.

### Modification Example 2

Furthermore, the first embodiment is described based on the example case where a specific player (e.g., the team leader) performs the gathering request operation as the directing player to execute (start) the gathering event, and the players in the same team participate in the gathering event as the participating players. More specifically, the players who satisfy the participation condition X543 (see FIG. 3) of the gathering event to be executed are compulsorily made the participating players. However, any player may be allowed to become the directing player to invite predetermined target players playing the game to participate in the gathering event, and the target players who announced their participation may be made the participating players. For example, the entire players playing the game can be made the target players regardless of the teams. Alternatively, part of the entire players may be made the target players. For example, a condition for becoming the target player (a condition for participating in the event) may be set beforehand, so that the players who satisfy the condition can be the target players.

According to the present modification example, the gathering event start control section X233 in the server system X1100 performs a control for displaying an announcement screen for announcing the execution of the gathering event on the user terminal X1500 of each target player before the start control of the gathering event in response to a predetermined announcement operation by the directing player.

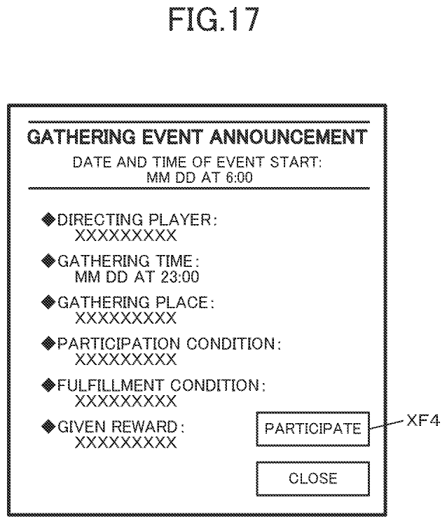

FIG. 17 is a diagram illustrating an example of the announcement screen. As illustrated in FIG. 17, the announcement screen shows content of the gathering event to be executed, that is, a start date and time, a directing player, a gathering place, a gathering time, a participation condition, a fulfillment condition, a given reward of the gathering event, for example, and a participation operation made by a participation button XF4 is accepted. The target players check the content of the gathering event to be executed in the announcement screen of the gathering event, and perform the participation operation by touching the participation button XF4 for participation.

The gathering event start control section X233 accepts the participation operation for the gathering event from the user terminal X1500 of each target player until a predetermined announcement period ends. Acceptance of the participation operation may be closed when a predetermined time period has passed after the announcement. Alternatively, a quota may be set for each gathering event to be executed beforehand, and the acceptance may be closed when the number of participation operations reaches the quota of the gathering event. Accordingly, the target players who performed the participation operations during the announcement period are set as the participating players of the gathering event.

After that, the server system X1100 controls the start of the gathering event announced, and executes the gathering event in a manner similar to that in the first embodiment. In a case that the start date and time of the gathering event is fixed in the announcement, the server system X1100 performs the start control when the start time comes.

### Modification Example 3

Furthermore, according to the first embodiment, the content of the gathering event is defined as the event definition data X530 beforehand. However, the directing player may specify the various event detail items such as the gathering place, the gathering time, the fulfillment condition, or the reward. In such a case, the server system X1100 accepts a specifying operation of the event detail items before the gathering request operation. When the server system X1100 detects the specifying operation on the user terminal X1500 of the directing player, the server system X1100 sets the respective event control items in accordance with the specifying operation, and then accepts the gathering request operation by the directing player. Then, upon acceptance of the gathering request operation, the server system X1100 controls the start of the gathering event, and executes the gathering event based on the event control items set in accordance with the specifying operation. As a result, the directing player can determine the content of the gathering event to be executed.

### Modification Example 4

Furthermore, according to the first embodiment, the event success/failure determination is made with the prerequisite condition requiring that the participating user arrive at the gathering place by the gathering time. However, the event success/failure determination may be made with a prerequisite condition requiring that the participating user arrive at the gathering place without restriction on the arrival time. In such a case, the gathering event may be terminated when a gathered number of participating users reaches a predetermined number. The reward content X555 in this case is preferably set in order of arrival as in the example in FIG. 6.

### Modification Example 5

According to the first embodiment, the game content is described as an example of the content. However, in addition to the game content, the first embodiment can be applied to any other content if the content includes communication connections with terminals of a plurality of users, and allows each of the plurality of users to operate his/her user character while each user is watching an image of a virtual space that the plurality of users share. For example, the first embodiment can be applied to event content for an activity event of sports where a gathering place is specified, and participants compete in teams for time to gather at the gathering place, or event content for orienteering where participants advance in order in search of the gathering place.

### Second Embodiment

Next, the second embodiment is described.

The second embodiment is described using an example of the game content that progresses based on a user position that is a position of a user terminal. However, in addition to the game content, the second embodiment can be applied to any content that the user having the user terminal enjoys with the real space as the play field.

[Game According to Second Embodiment]

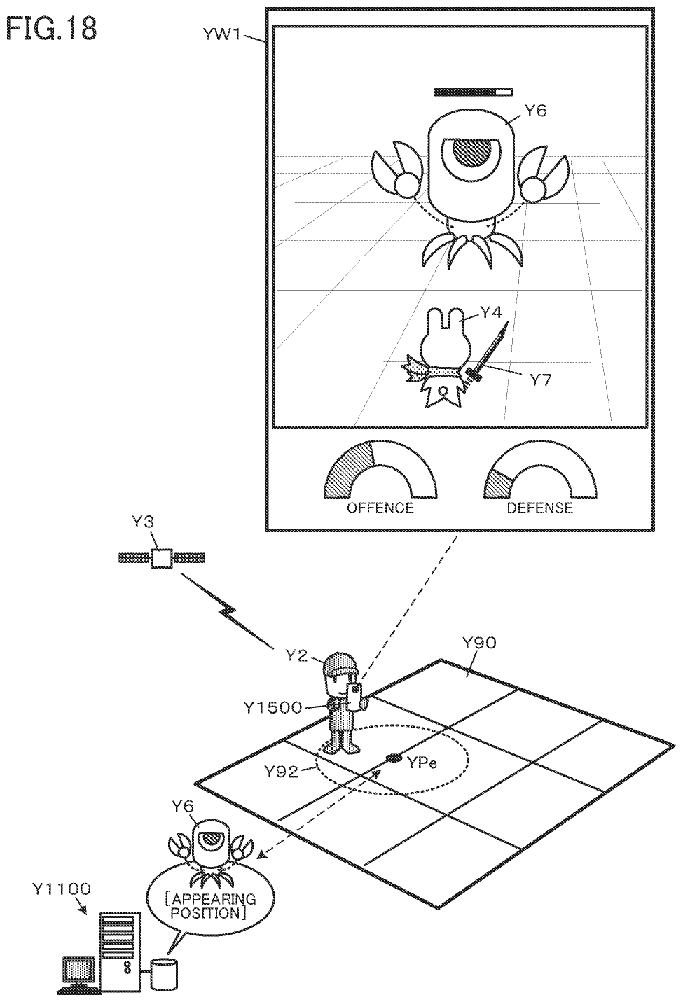

FIG. 18 is a diagram illustrating an outline of a game according to the second embodiment. The game according to the second embodiment is an action RPG using streets in a real space Y90 as a play field. When a user Y2 moves in the real space Y90, an enemy character Y6 appears in a game screen YW1 depending on a user position, and the user can fight against the enemy character Y6 using a player character Y4 that the user selects. The user Y2 can also acquire a game object such as an item Y7 that the player character Y4 can be equipped with by moving in the real space Y90.

In particular, when the user Y2 takes a user terminal Y1500 outside (in an environment where the positioning module 1555 can be used, more specifically, an environment where a signal from a GPS satellite Y3 can be received), and moves, appearance timing of the enemy character Y6 or a type and the number of enemy characters Y6 are controlled based on positioning information measured by the user terminal Y1500. In addition, a predetermined game object is given to the user Y2 based on the positioning information measured by the user terminal Y1500.

For that purpose, the server system Y1100 associates position coordinates indicating a predetermined appearing position YPe in the real space Y90 with setting information on a type and the number of enemy characters Y6, and stores and manages this information. On the other hand, the user terminal Y1500 associates the positioning information measured by the user terminal Y1500 with an account of the user Y2 using the user terminal Y1500 to periodically or intermittently send to the server system Y1100. Then, when a latest user position received from the user terminal Y1500 enters an appearing area Y92 calculated based on the appearing position YPe, the server system Y1100 causes the enemy character Y6 associated with the appearing position to appear in a game screen YW1.

Similarly, the server system Y1100 associates position coordinates indicating a predetermined giving position in the real space Y90 with a type of game object to be given (hereinafter referred to as a “given object”) to store and manage. Then, when the latest user position received from the user terminal Y1500 enters a giving area calculated based on the giving position, the server system Y1100 performs a control for giving the given object associated with the giving position to the user Y2.

The game object includes various types of items that a player character can possess or use such as a weapon, a protection, a bullet, or medicine, a character selectable as a player character, a vehicle of a player character, a summoned beast, an additional ability that can be added to a player character such as magic or a skill, unlocking of a new stage or a map, a right of lottery (a lottery ticket) for getting an item or a character by lottery, or the like.

Furthermore, with the game according to the second embodiment, the gathering event is held in the real space Y90 such as a restaurant, a retail store, a business store in a service industry, a station, a school, or a sight-seeing area by using an augmented reality (AR) or a mixed reality (MR).

For that purpose, the server system Y1100 accepts the gathering request operation by the directing user, and executes the gathering event that gathers participating users at a given gathering place existing in the real space during the game. Furthermore, according to the second embodiment, a plurality of types of event execution items are prepared as items available for the user during the gameplay. The server system Y1100 accepts the use of the event execution item as the gathering request operation (this can be considered as a selection operation of the event definition data Y530 to be described later). In addition, the user who has performed this operation is set as the directing user.

An acquisition condition of the event execution item may be set as appropriate. For example, the acquisition condition can be set to that the user acquires the item as a dropped object by defeating the enemy character Y6 that appears as the user moves in the real space Y90, as described above, or that the user acquires the item as a given object when the user actually moves to a giving position associated with the given object set to the event execution item. The acquisition condition can also be set to that the user acquires the item as a login bonus or prizes of various events, or by a lottery called gacha. The acquisition condition can be set to that the user acquires (purchases) the item in exchange for the spending of the game coins of a predetermined amount. The game coins are the in-game currency provided through the purchase procedure (the charging process) by the user. Instead of the game coins, the user may acquire the item in exchange for the spending of the points provided to the user during the game. The acquisition condition can also be set to that the user satisfies an acquisition condition that the user executes another game, visits an advertisement web page, or the like.

According to the second embodiment, each of the event execution items is previously set with the event definition data defining the content of the gathering event, and the server system Y1100 executes the gathering event based on the event definition data relating to the event execution item used. As for a procedure, the server system Y1100 first sets the participating users or the like, and controls the start of the gathering event (event start control process). Then, the server system Y1100 also controls the display of the map image displaying the gathering place in the real space in the identifiable display mode in the game screen on the user terminals X1500 of the directing user and the participating user (game screen display control process). Then, the server system Y1100 performs the event success/failure determination of the gathering event using the user position of each participating user at appropriate timing (event success/failure determination process). According to the second embodiment, the participating user is required to satisfy the prerequisite condition that is the position condition requiring that the participating user arrive at the gathering place by the gathering time. In addition, the participating user is further required that the actions of the participating user and/or a progress status of the game before the arrival satisfy the fulfillment condition. The server system Y1100 determines the success/failure of the gathering event (whether the gathering condition is satisfied) based on the number of participating users who have received the affirmative determination in the individual determination of fulfillment of these conditions. Consequently, the server system Y1100 gives the directing user and/or the participating user the given reward when the server system Y1100 determines that the gathering event is a success in the event success/failure determination (reward giving process). When a service reward is given as the reward, the server system Y1100 bills an advertiser for advertising expenses corresponding to the service reward given (advertising expense billing process).

1. Event Definition Data

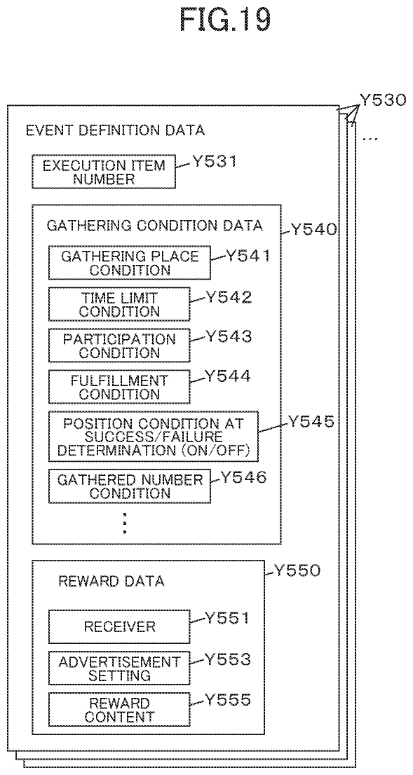

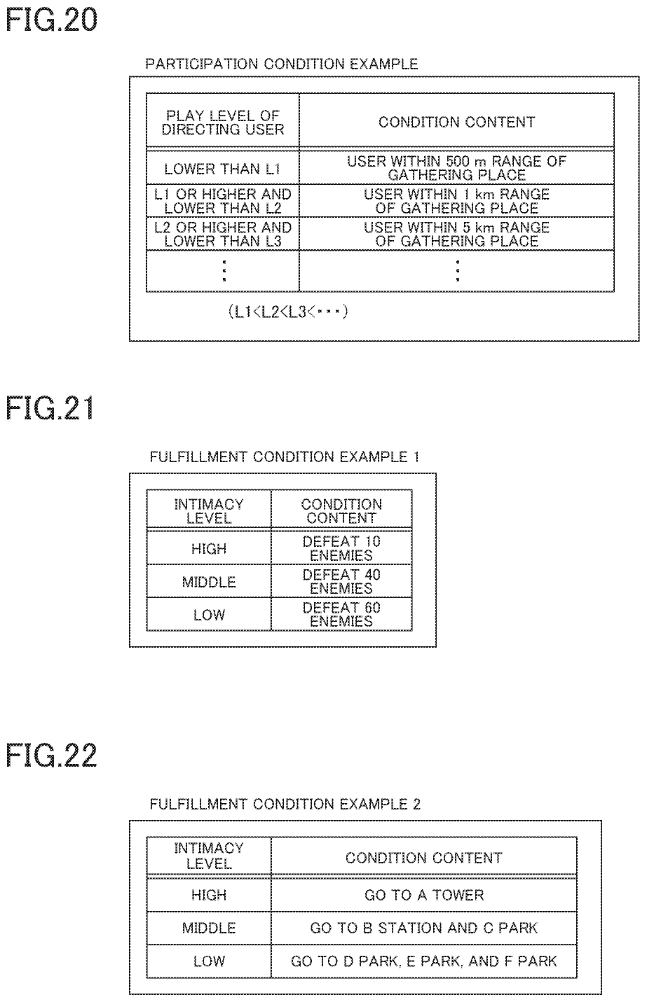

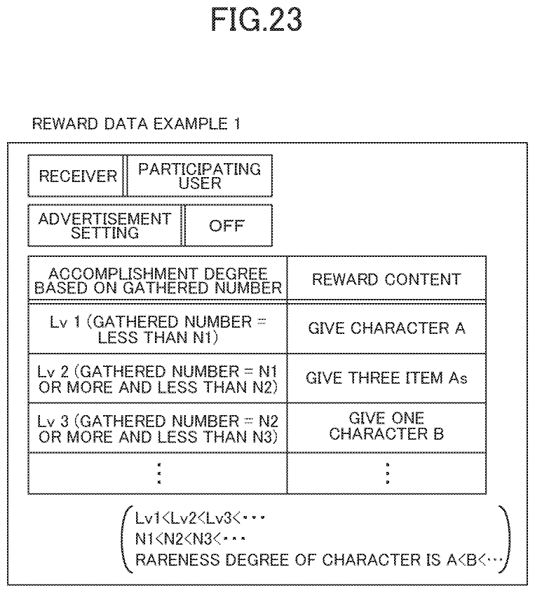

FIG. 19 is a diagram illustrating an example of a data configuration of the event definition data Y530. As illustrated in FIG. 19, one piece of event definition data Y530 includes an execution item number Y531, gathering condition data Y540, and reward data Y550. The gathering condition data Y540 includes a gathering place condition Y541, a time limit condition Y542, a participation condition Y543, a fulfillment condition Y544, a position condition Y545 at a success/failure determination, and a gathered number condition Y546 in relation to the gathering event. The reward data Y550 includes a receiver Y551, an advertisement setting Y553, and reward content Y555 in relation to the gathering event. FIG. 20 illustrates an example of the participation condition Y543, FIGS. 21 and 22 illustrate examples of the fulfillment condition Y544, and FIGS. 23 to 26 illustrates examples of the reward data Y550.

The gathering place condition Y541 specifies the position of the gathering place in the real space in the gathering event. For example, position coordinates (latitude/longitude/altitude) of a specific place such as a store or a station is set along with a facility name.

The time limit condition Y542 specifies a limited time period of the gathering event. According to the second embodiment, the gathering time of the gathering event is set in accordance with the time limit condition Y542. That is, the server system Y1100 sets the gathering time to the time when an elapsed time period from a start time (when the event execution item is used) reaches the specified limited time period in the start control of the gathering event. The time may be consistent with the time in a real world, or may be the time in a game world.

The participation condition Y543 specifies the participating users in the gathering event. For example, the participation condition Y543 can specify all the users participating in the game other than the directing user as the participating users, or all the users including the directing user as the participating users. In the former case, the directing user does not need to go to the gathering place. In the latter case, since the directing user is also the participating user, the directing user starts the gathering event by the gathering request operation and participates in the gathering event that he/she has started to successfully accomplish the gathering event.

More specifically, in addition to the setting of whether to include the directing user in the participating users, for example, the participation condition Y543 can include a setting requiring that the user be participating in the game, that the user be enrolled in a friend registration of the directing user, that the player level have reached a predetermined level, that the user have spent the points of a predetermined amount, or the like, or a combination thereof. In such a case, the users who satisfy the condition are set as the participating users. Alternatively, the participation condition Y543 may include a condition that specifies specific users as the participating users. For example, the participation condition Y543 may include a setting requiring that the user be appointed by the directing user. In such a case, the server system separately accepts an appointing operation from the directing user to set the participating users.

In addition, the participation condition Y543 can include a setting specifying a distance (moving distance) to the gathering place specified by the gathering place condition Y541, or a time (moving time) required to move to the gathering place. In such a case, based on the user position of each user participating in the game, the users whose moving distances to the gathering place are within a given setting value are set as the participating users. In a case that the moving time is specified, the distance from the user position of each user to the gathering place is converted into the moving time. Then, the users whose moving times obtained are within a given setting value are set as the participating users.

Furthermore, the participation condition Y543 may be set such that the setting value of the moving distance or the like varies depending on the player level of the directing user. For example, in the example in FIG. 20, the content of the condition is set in association with the player level of the directing user such that an allowable moving distance increases as the player level of the directing user rises. Accordingly, when a user at a higher player level uses the event execution item relating to this participation condition Y543 to become the directing user, the users in a further range can be the participating users to participate in the gathering event.

The fulfillment condition Y544 is a condition relating to the actions of each participating user in the real space or the progress status of the game before the arrival at the gathering place. For example, the fulfillment condition Y544 can include a condition of the actions of the participating user that specifies a facility or the like in the real space to visit before the participating user gathers at the gathering place, and a condition of the progress status of the game that specifies a type and the number of enemy characters to defeat, an item to acquire, or the like before the participating user gathers at the gathering place. Alternatively, the condition may include a combination thereof. Accordingly, the participating user needs to take the actions or perform the gameplay to satisfy the fulfillment condition during the gathering event, and then arrive at the gathering place by the gathering time.

More specifically, the fulfillment condition Y544 includes settings having different degrees of difficulty corresponding to the intimacy levels of the participating user with respect to the directing user. For example, when the fulfillment condition for each intimacy level is the number of characters to defeat, the number is set to decrease as the intimacy level rises. When the fulfillment condition for each intimacy level is an item to acquire, a type of item having lower difficulty in acquiring is set as the intimacy level rises. Accordingly, the fulfillment condition that is easier to accomplish can be set for the participating user having higher intimacy with respect to the directing user. For example, in the example in FIG. 21, the intimacy levels include three stages of high, middle, and low, and are respectively set with the fulfillment conditions each specifying a different number of enemy characters to defeat.

Alternatively, when the fulfillment condition for each intimacy level is a facility in the real space to visit, the number is set to decrease as the intimacy level rises, or the distance to the facility from the gathering place is set to decrease as the intimacy level rises. For example, the example in FIG. 22 illustrates the fulfillment condition specifying a different number of facilities to visit for each intimacy level.

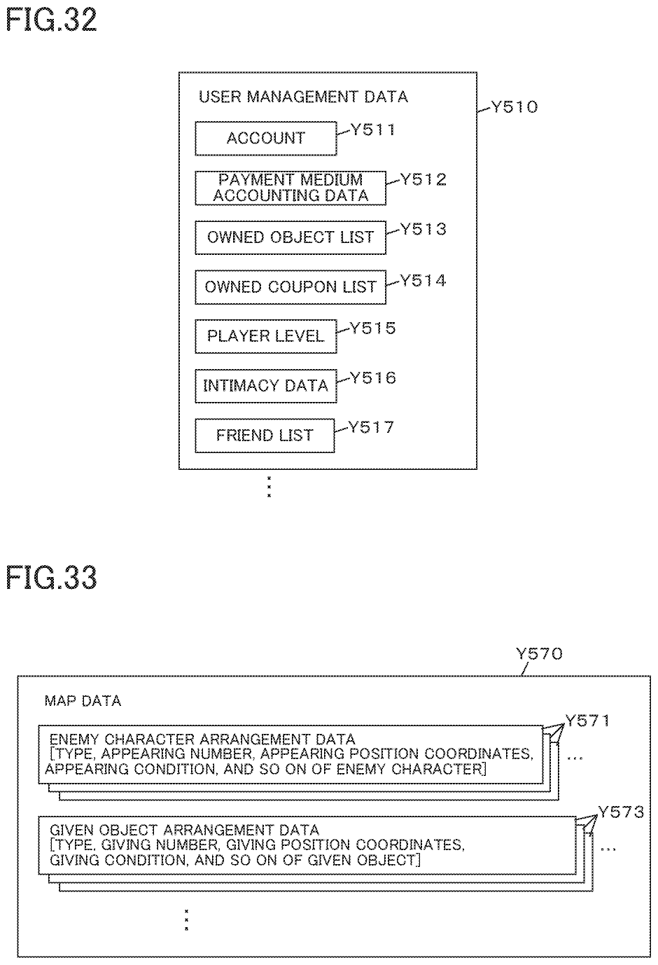

The intimacy level used here indicates differences in the intimacy index values between the directing user and the participating user. The intimacy index value is an index value indicating the intimacy between the users, and the server system Y1100 manages for each user the intimacy index values with respect to other users (intimacy data Y516 in FIG. 32). In particular, the server system Y1100, for each user with respect to all other users, updates and manages the intimacy index value between the user and another user at any time based on the number of times or a frequency of chat during the gameplay, the number of times or a frequency of giving and/or receiving game objects, or the like. With the game to play in teams, the intimacy index value may be updated based on the number of times or a frequency of playing the game together with the another user. Accordingly, if the user frequently chats with a specific user, repeatedly makes a team with the specific user to play the game, the intimacy index value between the user and the specific player rises.

The stages of the intimacy level are not limited to the three stages of high, middle, and low, described above, and may include two, four, or more stages. Instead of the intimacy index value, enrollment in a friend registration may be used. For example, the content of the fulfillment condition Y544 with the enrolment in the friend registration can be set to have a lower degree of difficulty than the degree of difficulty of fulfillment condition Y544 without the enrollment in the friend registration so that the participating user enrolled in the friend registration of the directing user can accomplish the fulfillment condition easily.

The position condition Y545 at the success/failure determination is flag information that is used for the determination of the fulfillment of the prerequisite condition of whether the user gathered at the gathering place by the gathering time. The flag information indicates whether the participating user is required to be at the gathering place at the gathering time (ON in this case, for example), or the participating user is required only to move to the gathering place once by the gathering time after the start of the gathering event without restriction on the position at the gathering time (OFF in this case, for example).

The gathered number condition Y546 is a condition used for determining that the gathering event is a success in the event success/failure determination, and specifies the number of participating users who have received an affirmative determination in the individual determination. For example, for the success of the gathering event including the gathered number condition Y546 set to all, all the participating users need to receive the affirmative determination in the individual determination. On the other hand, when the gathered number condition Y546 is set to one, the gathering event is determined to be a success if any one of the participating users has received the affirmative determination in the individual determination.

The receiver Y551 in the reward data Y550 specifies the user who receives the reward of the reward content Y555. According to the second embodiment, the receiver Y551 is set to the directing user and/or the participating user.

The advertisement setting Y553 specifies an advertisement flag and advertiser information. The advertisement flag is flag information indicating whether the reward of the reward content Y555 is the service reward. When the reward is the service reward, the setting is ON, and when the reward is not the service reward, the setting is OFF. The advertiser information is set when the advertisement flag is ON, and includes various types of data necessary for specifying the advertiser relating to the service reward. When a method for determining the advertising expenses is defined for each advertiser, a setting of the method is also included as appropriate. The advertiser information is referred to in the advertising expense billing process.

The reward content Y555 specifies the content of the reward to be given when the gathering event is determined to be a success in the event success/failure determination. For example, the reward content Y555 includes a setting for giving a character or an item, unlocking a new game stage or map, or executing various game events such as executing a mini game. When the receiver Y551 is set to both the directing user and the participating user, the setting of the reward content Y555 may be the same for both the directing user and the participating user, or may be different.

More specifically, when the gathered number condition Y546 for the gathering event is set to a lower limit value such as one or more, as illustrated in FIG. 23, for example, different reward content is set correspondingly to an accomplishment degree based on the gathered number. The accomplishment degree (Lv1, Lv2, LV3, . . . ) is specified by a range of the gathered number. The reward content is adjusted such that the rareness degree of a game object to be given becomes higher or the number of game objects to be given becomes larger as the accomplishment degree becomes higher. Accordingly, the reward to be given can be made different in accordance with the actual gathered number, and for example, a more splendid reward can be given as the gathered number becomes larger. On the contrary, the reward may be set to be more splendid as the gathered number becomes smaller. The number of stages of the accomplishment degree is not particularly limited, and the range of the gathered number may also be set as appropriate. Each value N1, N2, N3, and so on defining the gathered number may be a fixed value or may be set variably for each gathering event in accordance with the number of participants in the gathering event.

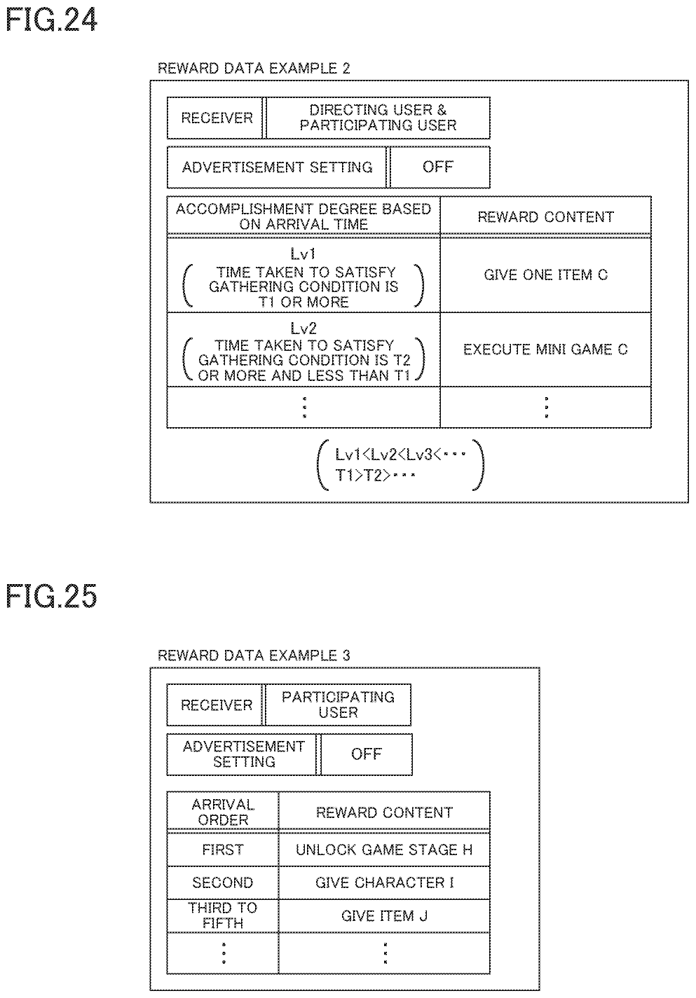

Alternatively, as illustrated in FIG. 24, different reward content can be set in the reward data correspondingly to the accomplishment degree based on the arrival time. The accomplishment degree (Lv1, Lv2, LV3, . . . ) is specified by the time (an accomplishment time) taken to satisfy the gathering condition after the start of the gathering event. Then, similar to the accomplishment degree based on the gathered number, the reward content is adjusted such that the rareness degree of a game object to be given becomes higher or the number of game objects to be given becomes larger as the accomplishment degree becomes higher. Accordingly, the reward to be given can be made different in accordance with the accomplishment time, and for example, a more splendid reward can be given as the accomplishment time is shorter. The number of stages of the accomplishment degree is not particularly limited, and the range of the accomplishment time may also be set as appropriate. Each value T1, T2, and so on defining the accomplishment time may be a fixed value or may be set variably for each gathering event.

Furthermore, as illustrated in FIG. 25, different reward content may be set in the reward data for each position in a ranking of the arrival time (arrival order) at the gathering place. For example, a more splendid reward may be set for the user who ranks higher in the arrival order. This setting can add a game element of competing for the arrival order at the gathering place to the gathering event. In addition, the reward content can include a setting to give a reward for the participation to users who have received a negative determination in the individual determination among the participating users.

Furthermore, in the reward data Y550 including the advertisement setting Y553 set to ON, the reward content Y555 is set to the service reward that entitles the user to receive a given service from a given advertiser. For example, the service reward may be giving a coupon such as a discount coupon or a money exchange coupon usable at a specific store. In such a case, the reward content Y555 can include a setting of the service reward unrelated to the gathering place and a setting of the service reward related to the gathering place as appropriate. The latter case can be implemented when the gathering place condition Y541 is set to a store, and the reward content Y555 is set to the service reward of giving a coupon usable at the store.

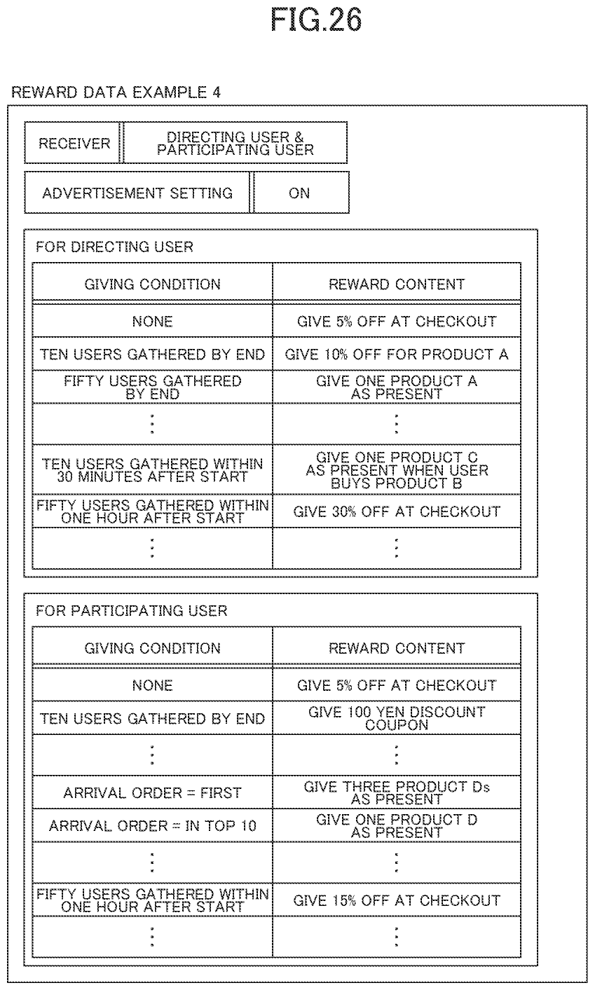

For example, in the example of the reward content of the reward data in FIG. 26, a plurality of service rewards set for the directing user are different from a plurality of service rewards set for the participating user. In particular, the reward content in this example is associated with a giving condition limiting the gathered number or the arrival order, and the service reward associated with the satisfied giving condition is given to the directing user or the participating user. When a plurality of giving conditions are satisfied, all the associated rewards may be given, or some of the associated rewards may be selected to give.

2. Event Start Control Process

In the event start control process, the operation to use the event execution item by the user participating in the game is accepted as the gathering request operation. Then, the gathering place is set based on the gathering place condition Y541 of the event execution item used, the gathering time is set based on the time limit condition Y542, the participating users are set based on the participation condition Y543, and the fulfillment condition is set based on the fulfillment condition Y544 so as to control the start of the gathering event.

3. Game Screen Display Control Process

The map image and the view image are displayed using the augmented reality or the like in a switchable manner on the game screen of the user terminal Y1500 during the game. In the game screen display control process, the display of the map image and the view image is controlled in the first place. That is, the map image of the real space of the play filed and the view image is displayed on the game screen of each user participating in the game based on the current (latest) user position of the user terminal in accordance with the switching operation by the user. The map image may be displayed on the view image all the time.

3-1. Map Image

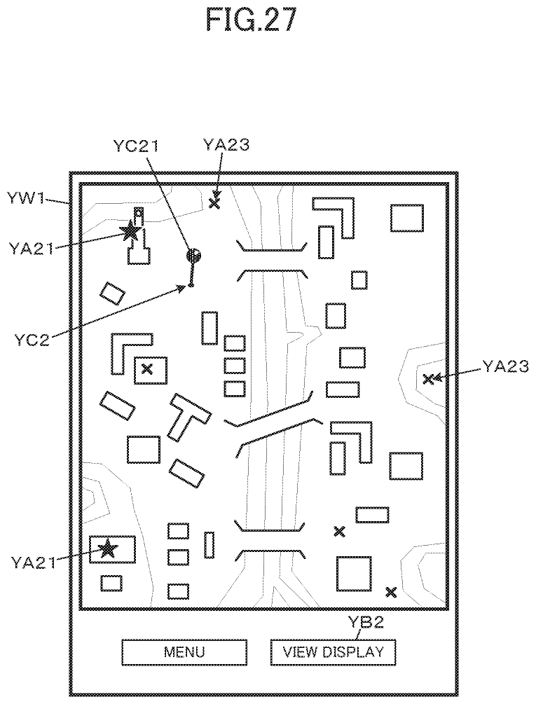

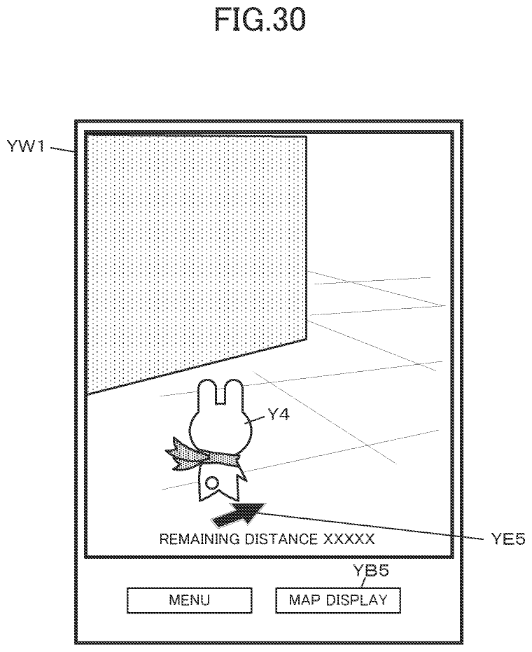

FIG. 27 is a diagram illustrating a display example of the map image on a game screen YW1. The map image includes a map showing the real space based on the user position of the user terminal, and a marker YA 21 indicating the user position, a marker YA23 indicating an appearing position of an enemy character, and a marker YA25 indicating a giving position of a given object displayed on the map. The map image can be used to understand positional relationships among these elements, and to understand a positional relationship with respect to the destination. Although not illustrated in FIG. 27, a marker indicating a position of another user may be display as appropriate. With a touch operation of a view display button YB2 on the game screen YW1, the map image can be switched to the view image (see FIG. 30).

FIG. 27 illustrates the map screen during the gathering event. In the game screen display control process, a control for displaying a gathering place YC2 in the identifiable display mode on the map image during the gathering event is performed in the second place. In the example in FIG. 27, the gathering place YC2 is displayed in the identifiable manner by a display of a pin YC21 stuck on the gathering place YC2.

Furthermore, in the game screen display control process, a control for displaying various event detail items of the gathering event is performed in association with the display of the gathering place YC2 in the third place. This display control of the event detail items is performed in response to a touch operation in a vicinity of the gathering place YC2 on the user terminal Y1500, for example. When this operation on the user terminal Y1500 of the participating user is detected, a detail screen for the participant is displayed on the map image.

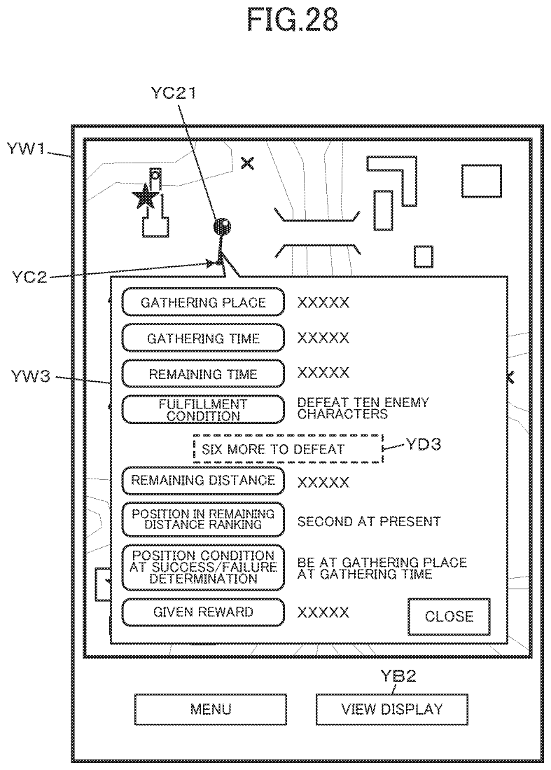

FIG. 28 is a diagram illustrating a display example of a detail screen YW3 for the participant. As illustrated in FIG. 28, the event detail items displayed in the detail screen YW3 for the participant include a gathering place, a gathering time, a remaining time, a fulfillment condition, a fulfilled status of the fulfillment condition, a remaining distance, a position in a remaining distance ranking, a position condition at the success/failure-determination, and a given reward in relation to the gathering event. Only some of these event detail items may be displayed.

The fulfilled status of the fulfillment condition indicates how much the user (the participating user using the user terminal Y1500) has fulfilled the fulfillment condition at the point when the detail screen YW3 for the participant is displayed. This corresponds to a display YD3 shown by a broken line in FIG. 28. The remaining distance is a distance from the user position (the current position of the user terminal Y1500) to the gathering place YC2. The position in the remaining distance ranking indicates the position of the participating user in the ranking of the remaining distance of each participating user. According to the second embodiment, the remaining distance ranking ranks the remaining distance of each participating user in order from shortest. In the example in FIG. 28, the user can see that he/she is at a second closest position to the gathering place YC2 among the participating users. The given reward indicates the reward that the participating user can acquire by the gathering event.

With the display of the detail screen YW3 for the participant, the participating user can work toward successfully accomplishing the gathering event while knowing the gathering time (remaining time), the actions that the user needs to take by then, or the like during the gathering event, for example.

Furthermore, in the game screen display control process, a control for displaying the gathering status of each participating user based on the remaining distance of the participating user in the gathering event is performed in association with the display of the gathering place YC2 in the fourth place. The display control of the gathering status is performed in response to a touch operation in the vicinity of the gathering place YC2 on the user terminal Y1500, for example. When this operation on the user terminal Y1500 of the directing user is detected, a detail screen for the director is displayed on the map image.

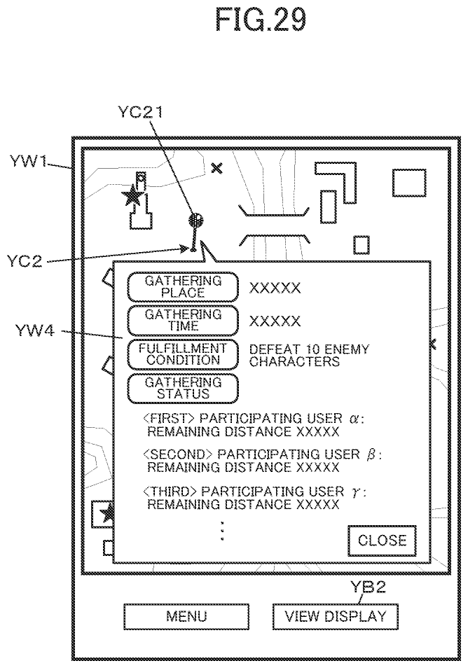

FIG. 29 is a diagram illustrating an example of a detail screen YW4 for the director. As illustrated in FIG. 29, the detail screen YW4 for the director displays a gathering place, a gathering time, a fulfillment condition, and a gathering status of the gathering event, for example.

The gathering status displays the remaining distance of each participating user at the point when the detail screen YW4 for the director is displayed. In FIG. 29, the remaining distance of each participating user is displayed in order of the remaining distance ranking. The fulfilled status of the fulfillment condition of each participating user may be displayed together with the remaining distance. Furthermore, the required time (moving time) that the participating user requires to move to the gathering place YC2 may be calculated for each participating user from the remaining distance of the participating user, so as to display the required time together with the remaining distance. Alternatively, the required time may be displayed instead of the remaining distance.

With the display of the detail screen YW4 for the director, the directing user can see whether each of the participating user is approaching the gathering place YC2 during the gathering event. The content (the item of the gathering status) of the detail screen YW4 for the director may also be displayed on the user terminal Y1500 of the participating user so that the participating user can see the content.

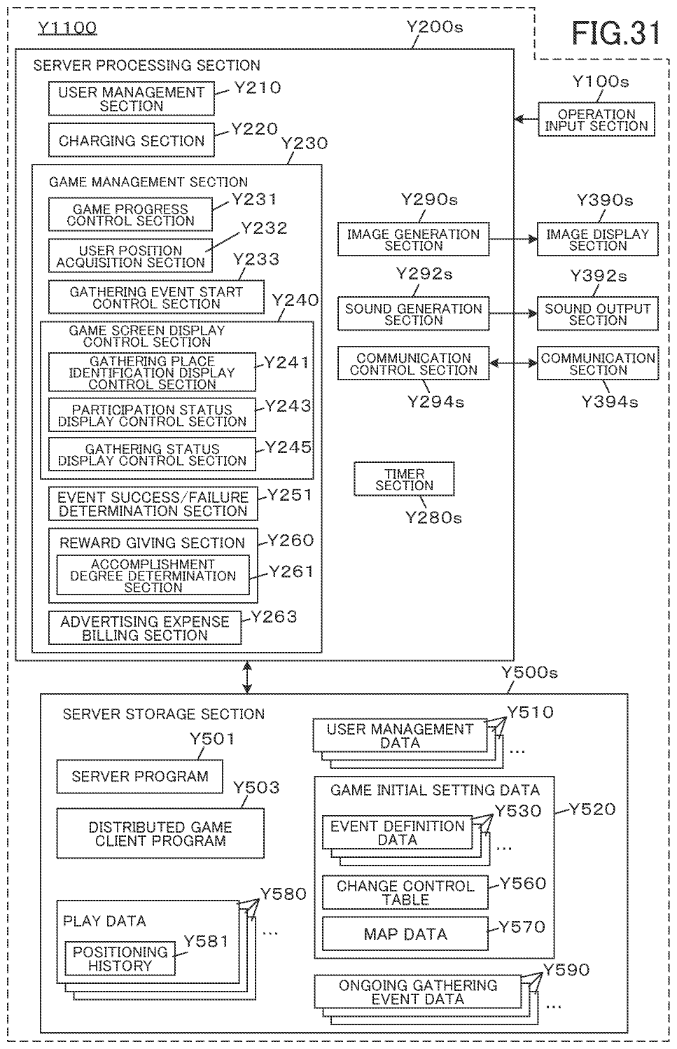

Furthermore, in the game screen display control process, a control for changing the display mode of the gathering place YC2 in the map image during the gathering event is performed in accordance with the remaining time to the gathering time in the fifth place. According to the second embodiment, the display mode of the pin YC21 indicating the gathering place YC2 in the identifiable manner is controlled to change. For that purpose, for example, a change control table Y560 (see FIG. 31) defining a correspondence relation between the length of the remaining time and the display mode of the pin YC21 is prepared beforehand. For example, display color is set to differ for each length of time. More distinct color is preferably set for a shorter length of time. Alternatively, a shape or size of the pin YC21 may be set to differ for each length of time, or the display mode for each length of time may be defined by a combination of these elements. Then, the change control of the display mode is performed by controlling the display of the pin YC21 in accordance with the setting of the display mode corresponding to the actual remaining time for each user terminal Y1500 of the directing user and the participating user. As a result, the participating user can visually recognize that the remaining time becomes short from the display mode of the gathering place YC2 on the map image.

The change control of the display mode may be performed only to the user terminal Y1500 of the participating user, and not to the user terminal Y1500 of the directing user.

Furthermore, the display mode of the gathering place YC2 may be changed in accordance with the remaining distance of the participating user. This control can be performed instead of the change control relating to the remaining time described above, or both may be performed. In such a case, for example, the correspondence relation between the remaining distance and the display mode of the pin YC21 is defined beforehand. Then, the display of the pin YC21 is controlled in accordance with the display mode corresponding to the actual remaining distance of the participating user using the user terminal Y1500 for each user terminal Y1500 of at least the participating user. As a result, the participating user can visually recognize that he/she is near the gathering place from the display mode of the gathering place YC2 on the map image.

Alternatively, in addition to the remaining distance of the participating user using the user terminal Y1500, the remaining distances of other participating users may also be used to change the display mode. For example, the correspondence relation between the number of participating users approaching the gathering place YC2 and the display mode of the pin YC21 is defined beforehand. Then, the participating users whose remaining distances are actually equal to or shorter than a predetermined threshold value are determined to be approaching the gathering place YC2, and the display of the pin YC21 is controlled in accordance with the display mode corresponding to the number of participating users approaching the gathering place YC2. As a result, the participating user and/or the directing user can visually recognize whether the number of participating users close to the gathering place is large or not from the display mode of the gathering place YC2 on the map image.

3-2. View Image

FIG. 30 is a diagram illustrating a display example of the view image on the game screen, and the view image is displayed on the user terminal Y1500 of the participating user during the gathering event. As illustrated in FIG. 30, in the game image for the participating user during the gathering event, a direction display body YE5 indicating a direction of the gathering place by a direction of an arrow is displayed near a player character Y4 operated by the participating user. The direction display body YE5 is accompanied with a display of the remaining distance to the gathering place. In addition to the remaining distance, another event detail item such as the position in the remaining distance ranking or the fulfilled status of the fulfillment condition, the required time described above, or the like can be displayed as appropriate. With a touch operation of a map display button YB5 on a game screen W1, the view image can be switched to the map image (see FIG. 28).

4. Event Success/Failure Determination Process

According to the second embodiment, the event success/failure determination process is performed at the gathering time, and the individual determination for each participating user is performed at first. That is, when the gathering time comes, it is determined whether the prerequisite condition is satisfied from the user position of the participating user during the gathering event or the user position of the participating user at the gathering time in accordance with the position condition at the success/failure determination. Then, when the prerequisite condition is satisfied, it is determined whether the actions of the participating user before the user position of the participating user arrives at the gathering place satisfy the fulfillment condition of the participating user. When it is determined that the condition is satisfied, the participating user is given the affirmative determination in the individual determination. Then, it is determined whether the number of participating users who have received the affirmative determination in the individual determination satisfies the gathered number condition. When the number satisfies the condition, the gathering event is determined to be a success, and when the number does not satisfy the condition, the gathering event is determined to be a failure.

5. Reward Giving Process

In the reward giving process, the reward of the reward content is given to the user of the receiver (the directing user and/or the participating user) in accordance with the reward data of the gathering event when the gathering event is determined to be a success in the event success/failure determination.

More specifically, the reward giving process includes as appropriate a first accomplishment degree determination process for determining the accomplishment degree of the gathering condition based on the number of participating users, and a second accomplishment degree determination process for determining the accomplishment degree of the gathering condition based on the arrival time of the participating user at the gathering place. According to the second embodiment, as illustrated in FIG. 23, when the reward content is associated with the accomplishment degree of the gathered number, the first accomplishment degree determination process is performed to determine the accomplishment degree based on the number of actual gathered number (the number of participating users who have received the affirmative determination in the individual determination). Then, the reward in the reward content associated with the accomplishment degree determined is given. On the other hand, as illustrated in FIG. 24, when the reward content is associated with the accomplishment degree of the arrival time, the second accomplishment degree determination process is performed to determine the accomplishment degree based on the arrival time by obtaining the accomplishment time from the time when the gathering condition is satisfied. Then, the reward in the reward content associated with the accomplishment degree determined is given.

6. Advertising Expense Billing Process

When the service reward is given in the reward giving process, the advertising expense billing process is performed to bill the advertiser for the advertising expenses using the advertiser information. For example, the advertising expenses are calculated from the number of users (the directing user and/or the participating user) who have received coupons, a type of the given coupons, or the like, and the billing process to the advertiser is performed.

[Functional Configuration]

1. Server System

FIG. 31 is a block diagram illustrating an example of the functional configuration of the server system Y1100. As illustrated in FIG. 31, the server system Y1100 according to the second embodiment includes an operation input section Y100s, a server processing section Y200s, an image display section Y390s, a sound output section Y392s, a communication section Y394s, and a server storage section Y500s.

The operation input section Y100s is a means for inputting various operations for system management and maintenance, and can be implemented by, for example, a keyboard, a mouse, or a touch panel. The operation input section Y100s corresponds to the keyboard 1106 and the touch panel 1108 in FIG. 1.

The server processing section Y200s can be implemented, for example, by a processor including an arithmetic circuit such as a CPU, a GPU, an ASIC, or an FPGA, and an electronic component such as an IC memory. The server processing section Y200s controls input/output of data between device sections including the operation input section Y100s and the server storage section Y500s. The server processing section Y200s performs various calculation processes based on a predetermined program, data, an operation input signal from the operation input section Y100s, data received from the user terminal Y1500, and the like to integrally control the operation of the server system Y1100. The server processing section Y200s corresponds to the control board 1150 and the CPU 1151 thereon in FIG. 1.

The server processing section Y200s includes a user management section Y210, a charging section Y220, a game management section Y230, a timer section Y280s, an image generation section Y290s, a sound generation section Y292s, and a communication control section Y294s.

The user management section Y210 performs a process related to user registration and manages the data of each registered user associated with a user account. For example, the user management section Y210 can perform an issuing process of issuing a unique account to the registered user, a registration information management process of registering and managing personal information for each account, and a use history management process of managing a history of login and logout or the like. Of course, any other management processes for other data associated with the user account can be included as appropriate.

The charging section Y220 performs the charging process in response to the purchase operation of the game coins by the user, and provides the user with the game coins of the purchase amount.

The game management section Y230 performs various processes related to game execution management. According to the second embodiment, a multi-play game is implemented as a client-server online game. Thus, the game management section Y230 communicates with the user terminal Y1500 to perform a control for providing data required for gameplay. When the game is executed in the player-versus-player (PvP) manner, the game management section Y230 may execute the control relating to the matching of the players.

The game management section Y230 includes a game progress control section Y231, a user position acquisition section Y232, a gathering event start control section Y233, a game screen display control section Y240, an event success/failure determination section Y251, a reward giving section Y260, and an advertising expense billing section Y263.

The game progress control section Y231 communicates with the user terminals Y1500 of the plurality of players at any time, and controls the game that each player plays by operating his/her player character while moving in the real space.

The user position acquisition section Y232 performs a control for acquiring the positioning information sent periodically or intermittently from each user terminal Y1500. The positioning information acquired is accumulated as a positioning history Y581 in the play data Y580 of the player in accordance with the account sent with the positioning information.

The gathering event start control section Y233 is a functional section that performs the gathering event start control process. The gathering event start control section Y233 accepts the gathering request operation from the user terminal Y1500 of the directing user, and controls the start of the gathering event that gathers the participating users at the given gathering place in the real space.

The game screen display control section Y240 is a functional section that performs the game screen display control process, and performs a control for displaying the map image and the view image on the game screen on the user terminal Y1500 of each user playing the game in response to a switching operation by the user. The game screen display control section Y240 includes a gathering place identification display control section Y241, a participation status display control section Y243, and a gathering status display control section Y245.

The gathering place identification display control section Y241 performs a control for displaying the gathering place of the gathering event in the identifiable display mode when the map image is displayed on the user terminals Y1500 of the directing user and the participating user during the gathering event. Furthermore, the gathering place identification display control section Y241 performs a control for changing the display mode of the gathering place in accordance with the remaining time to the gathering time. For example, this control corresponds to the display control of the pin YC21 in FIG. 27 and the change control of the display mode of the pin YC21 corresponding to the remaining time.

The participation status display control section Y243 performs a control for displaying the event detail items including the fulfillment condition, the fulfilled status of the fulfillment condition, the remaining distance, the position in the remaining distance ranking, the gathering time, the remaining time to the gathering time on the user terminal Y1500 of each participating user in association with the display of the gathering place in the map image. This corresponds to the display of the detail screen YW3 for the participant (see FIG. 28) on the map image.

The gathering status display control section Y245 controls the display of the event detail items including the remaining distance of each participating user on the user terminal Y1500 of the directing user in association with the display of the gathering place in the map image. This corresponds to the display of the detail screen YW4 for the director (see FIG. 29) on the map image.

The event success/failure determination section Y251 is a functional section that performs the event success/failure determination process, and performs the event success/failure determination of the gathering event using the user position of the participating user.

The reward giving section Y260 is a functional section that performs the reward giving process, and gives the given reward to the directing user and/or the participating user when the gathering event is determined to be a success in the event success/failure determination. The reward giving section Y260 includes the accomplishment degree determination section Y261 that performs the first accomplishment degree determination process and the second accomplishment degree determination process.

The advertising expense billing section Y263 is a functional section that performs the advertising expense billing process, and performs a process for billing the advertiser for the advertising expenses of the service reward when the reward given by the reward giving section Y260 is the service reward.

The timer section Y280s uses a system clock to measure the current date and time, the limited time period, or the like.

The image generation section Y290s generates images related to the system management of the server system Y1100 or the like, and outputs the resultant to the image display section Y390s.

The sound generation section Y292s is implemented by execution of an IC or software for generating and decoding sound data, and generates or decodes sound data of operational sounds or BGM related to the system management of the server system Y1100 and video distribution, for example. Sound signals related to the system management are output to the sound output section Y392s.

The communication control section Y294s establishes a communication connection and performs data processing for data communication with an external device (e.g., the user terminal Y1500) through the communication section Y394s to implement exchange of data with the external device.

The image display section Y390s displays various screens for the system management based on the image signals input from the image generation section Y290s. For example, the image display section Y390s can be implemented by an image display device such as a flat panel display, a projector, or a head-mounted display. The image display section Y390s corresponds to the touch panel 1108 in FIG. 1.

The sound output section Y392s receives the sound signals input from the sound generation section Y292s to emit corresponding sounds. The sound output section Y392s corresponds to a speaker (not illustrated) included in the main body device 1101 or the touch panel 1108 in FIG. 1.

The communication section Y394s connects to the network N to implement communication. For example, the communication section Y394s can be implemented by a wireless communication device, a modem, a terminal adaptor (TA), a jack for wired communication cable, a control circuit, or the like. The communication section Y394s corresponds to the communication device 1153 in FIG. 1.

The server storage section Y500s stores a program for causing the server system Y1100 to operate to implement various functions included in the server system Y1100 and data used during the execution of the program. The program and the data are stored previously or temporarily at every process. For example, the server storage section Y500s can be implemented by an IC memory such as a RAM or a ROM, a magnetic disk such as a hard disk, or an optical disk such as a CD-ROM or a DVD. The server storage section Y500s corresponds to the IC memory 1152 and the storage 1140 in FIG. 1.

Furthermore, the server storage section Y500s stores a server program Y501, a distributed game client program Y503, user management data Y510, game initial setting data Y520, play data Y580, and ongoing gathering event data Y590. In addition, the server storage section Y500s stores necessary data such as a timer, a counter, or various types of flags as appropriate.

The server program Y501 is a program for causing the server processing section Y200s to function as the user management section Y210, the charging section Y220, and the game management section Y230. The server program Y501 may include programs for causing the server processing section Y200s to function as the image generation section Y290s, the sound generation section Y292s, and the communication control section Y294s as appropriate.

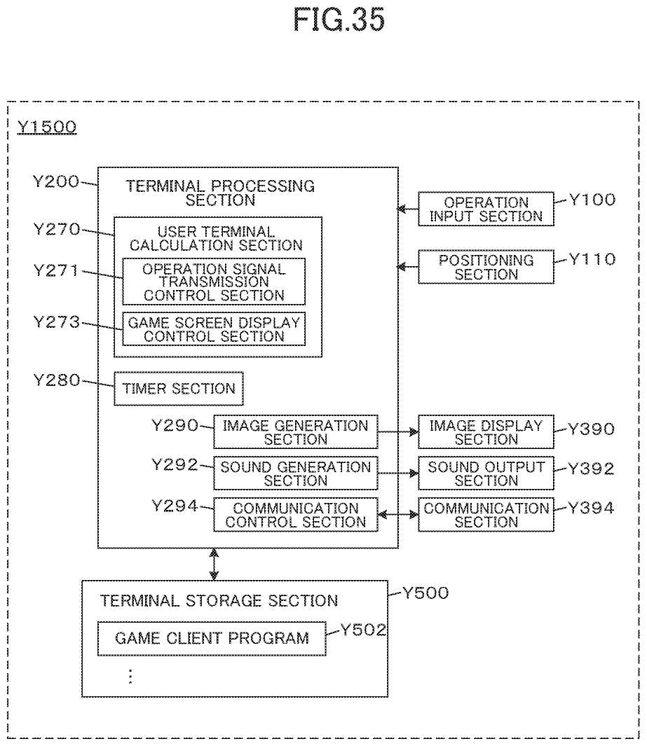

The distributed game client program Y503 is an original of a game client program Y502 (see FIG. 35) downloaded to the user terminal Y1500.

The user management data Y510 is prepared for each user who has registered as a user, and includes various types of data for management related to the gameplay of the user. In particular, one piece of user management data Y510 includes an account Y511 of the user, payment medium accounting data Y512, an owned object list Y513, an owned coupon list Y514, a player level X515, intimacy data Y516, and a friend list Y517 as illustrated in FIG. 32. In addition, the user management data Y510 may also include a play history such as a play date and time or a play time, saved data related to a progress status of the game, or the like.

The payment medium accounting data Y512 includes information on a balance of payment of an electronic payment media (the game coins of the in-game currency in the second embodiment) associated with the user such as a history of date and time of purchase of the game coins and the number of game coins purchased (a charging amount), and a history of date and time of spending of the game coins and the number of game coins spent.

The owned object list Y513 includes a list of the game objects such as a character, a weapon, or an item that the user has acquired during the game and owns at the moment. Furthermore, according to the second embodiment, when the game object is given as the reward of the gathering event, the object ID of the object is added to the owned object list Y513.

The owned coupon list Y514 includes a list of the coupons that the user has acquired as the rewards of the gathering events and owns at the moment.

The intimacy data Y516 includes the intimacy index values between the user and other users. The friend list Y517 includes accounts of other users enrolled in the friend registration of the player.

Refer back to FIG. 31. The game initial setting data Y520 includes initial setting data necessary for executing the game. The game initial setting data Y520 includes event definition data Y530, a change control table Y560, and a map data Y570. In addition, the game initial setting data Y520 includes player character initial setting data defining a type, initial values of various parameter values, model data, and motion data used for motion control of a character used as a player character, enemy character initial setting data defining a type, various parameter values, and action patterns of an enemy character, object definition data relating to various game objects that the user can acquire during the game, stage initial setting data relating to the setting of a game stage, data for a game event relating to the execution of the game event, or the like.

The map data Y570 includes information on a game element associated with position coordinates in the real space. In particular, the map data includes enemy character arrangement data Y571, and given object arrangement data Y573, as illustrated in FIG. 33.

The enemy character arrangement data Y571 is prepared for each appearing position YPe (see FIG. 18) of an enemy character, and includes various types of setting data such as a type of enemy character to appear at the appearing position YPe. One piece of enemy character arrangement data Y571 includes, for example, a type of enemy character, the number of enemy characters to appear, and position coordinates of the appearing position YPe. The enemy character arrangement data Y571 can also include a setting for an appearance condition such as a time period of a day, if any.

The given object arrangement data Y573 is prepared for each giving position of the given object, and includes various types of setting data such as a type of game object to be given at the giving position. One piece of given object arrangement data Y573 includes, for example, a type of given object, the number of given objects, and position coordinates of the giving position. The given object arrangement data Y573 can also include a setting for a giving condition such as a time period of a day, if any.

The play data Y580 is prepared for each user playing the game, and includes, in addition to the positioning history Y581, various types of data describing identification information on the user (e.g., the account Y511), and the progress status of the game of the user.

The ongoing gathering event data Y590 is generated by the gathering event start control section Y233 at the beginning of the gathering event.

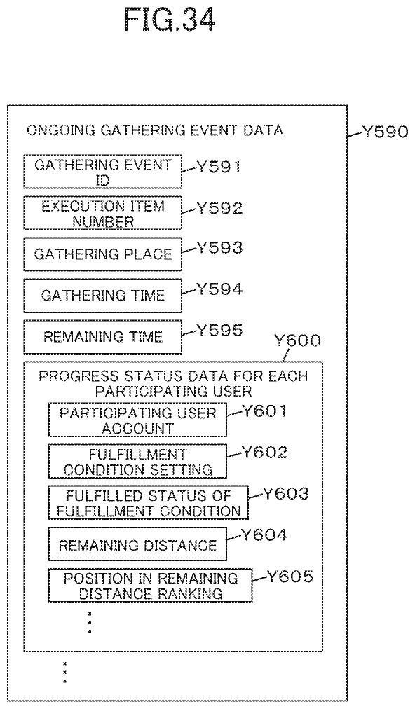

For example, as illustrated in FIG. 34, the ongoing gathering event data Y590 includes a gathering event ID Y591 for identifying the gathering event, an execution item number Y592 of the event execution item relating to the gathering request operation, a gathering place Y593 of the gathering event, a gathering time Y594, a remaining time Y595 to the gathering time, and progress status data Y600 for each participating user. The progress status data Y600 for each participating user is prepared for each participating user, and includes an account Y601 of the participating user, a fulfillment condition setting Y602 of the participating user, a fulfilled status Y603 of the fulfillment condition, a remaining distance Y604 to the gathering place Y593 from the current user position of the participating user, and a position Y605 in a remaining distance ranking of the participating user.

2. User Terminal

FIG. 35 is a block diagram illustrating an example of a functional configuration of the user terminal Y1500. As illustrated in FIG. 35, the user terminal Y1500 includes an operation input section Y100, a positioning section Y110, a terminal processing section Y200, an image display section Y390, a sound output section Y392, a communication section Y394, and a terminal storage section Y500.

The operation input section Y100 is used by a user to input various operations, and can be implemented, for example, by a button switch, a joystick, a touch pad, a track ball, an accelerometer, a gyro sensor, or a CCD module. The operation input section Y100 corresponds to the arrow key 1502, the home key 1504, and the touch panel 1506 in FIG. 2.

The positioning section Y110 acquires positioning information including a user position, and outputs the positioning information to the terminal processing section Y200. The positioning section Y110 corresponds to the positioning module 1555 in FIG. 2.

The terminal processing section Y200 can be implemented, for example, by a processor including an arithmetic circuit such as a CPU, a GPU, an ASIC, or an FPGA, and an electronic component such as an IC memory. The terminal processing section Y200 controls input/output of data between device sections including the operation input section Y100 and the terminal storage section Y500. The terminal processing section Y200 performs various calculation processes based on a predetermined program, data, an operation input signal from the operation input section Y100, data received from the server system Y1100, and the like to integrally control the operation of the user terminal Y1500. The terminal processing section Y200 corresponds to the control board 1550 and the CPU 1551 thereon in FIG. 2. The terminal processing section Y200 according to the second embodiment includes a user terminal calculation section Y270, a timer section Y280, an image generation section Y290, a sound generation section Y292, and a communication control section Y294.

The user terminal calculation section Y270 performs various calculation processes to cause the user terminal Y1500 to function as a terminal for the gameplay of the user. For example, the user terminal calculation section Y270 includes an operation signal transmission control section Y271, and a game screen display control section Y273.

The operation signal transmission control section Y271 performs a process of transmitting various types of data and request information to the server system Y1100 in accordance with an operation input performed on the operation input section Y100.

The game screen display control section Y273 performs a control for displaying a game screen based on various types of data received from the server system Y1100. For example, when the online game according to the second embodiment is implemented as a web game, the game screen display control section Y273 can be implemented by web technology that actively controls the screen display using Java (registered trademark) and cascading style sheets (CSS) along with HTML, with a web browser as a base, and by a plugin such as Adobe (registered trademark) Flash. Other methods may be employed, of course. Furthermore, the image on the game screen (e.g., 3DCG) is generated in the server system Y1100 according to the second embodiment. However, the image on the game screen may be generated in the user terminal Y1500. In such a case, the game screen display control section Y273 controls an object disposed in a virtual three-dimensional space for generating 3DCG.

The image generation section Y290 cooperates with the game screen display control section Y273 to generate an image signal for displaying one game screen in every one frame time (e.g., 1/60th of a second) based on the various types of data received from the server system Y1100, and to output the generated image signal to the image display section Y390. For example, the image generation section Y290 can be implemented, for example, by a processor such as a GPU or a digital signal processor (DSP), a video signal IC, a program such as a video codec, or a drawing frame IC memory such as a frame buffer.

The sound generation section Y292 is implemented, for example, by a processor such as a digital signal processor (DSP) or a sound synthesizing IC, or an audio codec for playing a sound file. The sound generation section Y292 generates sound signals for sound effects, BGM, and various types of operational sounds related to the game, and outputs the generated signals to the sound output section Y392.

The communication control section Y294 establishes a communication connection and performs data processing for data communication with an external device (e.g., the server system Y1100) through the communication section Y394, and implements exchange of data with the external device.

The image display section Y390 displays various screens such as a game screen based on the image signals input from the image generation section Y290. For example, the image display section Y390 can be implemented by an image display device such as a flat panel display, a projector, or a head-mounted display. The image display section Y390 corresponds to the touch panel 1506 in FIG. 2.

The sound output section Y392 emits sounds such as sound effects and BGM related to the game based on the sound signals input from the sound generation section Y292. The sound output section Y392 corresponds to the speaker 1510 in FIG. 2.

The communication section Y394 connects to the network N to implement communication. For example, the communication section Y394 can be implemented by a wireless communication device, a modem, a TA, a jack for wired communication cable, a control circuit, or the like. The communication section Y394 corresponds to the wireless communication module 1553 in FIG. 2.

The terminal storage section Y500 stores a program for causing the user terminal Y1500 to operate to implement various functions included in the user terminal Y1500 and data used during the execution of the program. The program and the data are stored previously or temporarily at every process. For example, the terminal storage section Y500 can be implemented by an IC memory such as a RAM or a ROM, a magnetic disk such as a hard disk, or an optical disk such as a CD-ROM or a DVD. The terminal storage section Y500 corresponds to the IC memory 1552 and the memory card 1540 in FIG. 2.

The terminal storage section Y500 stores the game client program Y502. The game client program Y502 is a program for causing the terminal processing section Y200 to function as the user terminal calculation section Y270. The game client program Y502 may be an exclusive client program depending on a technique and a method for implementing an online game or include a web browser program and a plugin that implements an interactive image display. According to the second embodiment, the game client program Y502 is a copy of the distributed game client program Y503 (see FIG. 31) provided from the server system Y1100.

[Flow of Processes]

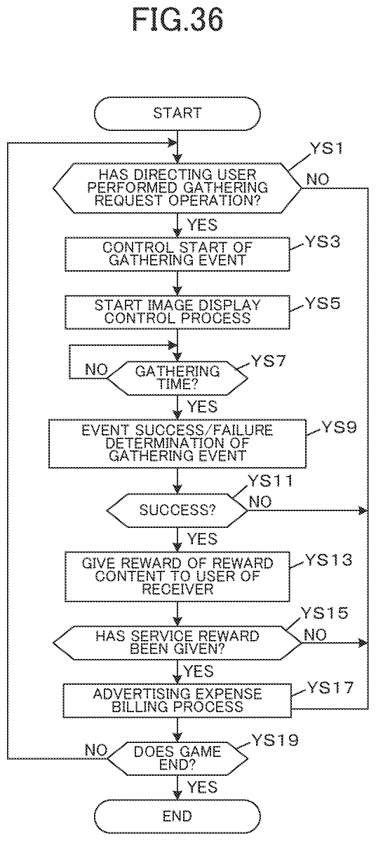

FIG. 36 is a flowchart illustrating a flow of processes relating to the execution of the gathering event in the server system Y1100. This series of processes as described herein are implemented by the server processing section Y200s reading out and executing the server program Y501. FIG. 36 shows a flow of the processes relating to the execution of a single gathering event.

Firstly, the gathering event start control section Y233 accepts the use of the event execution item by any of the users (the directing user) playing the game as the gathering request operation. Then, upon detection of the gathering request operation on the user terminal Y1500 of the directing user (step YS1: YES), the gathering event start control section Y233 sets the gathering place, the gathering time, the participating users, and the fulfillment condition for each participating user based on the event definition data Y530 (see FIG. 19) including the execution item number Y531 of the event execution item used to generate the ongoing gathering event data Y590, and performs the control for starting the gathering event (step YS3).

Then, the game screen display control section Y240 starts the display control of the game image displaying the gathering place in the real space in the identifiable display mode on the user terminals Y1500 of the directing user and the participating user (step YS5). According to the second embodiment, as described referring to FIGS. 27 to 30, the game screen display control section Y240 performs the display control of the gathering place in the map image in the identifiable manner, the change control of the display mode of the gathering place, the display control of the detail screen YW3 for the participant and the detail screen YW4 for the director, and the display control of the direction display body in the view image.

After that, when the gathering time comes (step YS7: YES), the event success/failure determination section Y251 performs the event success/failure determination of the gathering event based on the user position or the like of each participating user until the gathering time (step YS9). In particular, the event success/failure determination section Y251 performs the individual determination for each participating user based on the gathering place Y593, the gathering time Y594, and the fulfillment condition setting Y602 of each participating user (see FIG. 34) by using the setting for the position condition Y545 at the success/failure determination (see FIG. 19) or the like in the event definition data Y530 of the gathering event. Then, the event success/failure determination section Y251 determines the success/failure of the gathering event based on the number of participating users who have received the affirmative determination in the individual determination by using the setting for the gathered number condition Y546.

Then, when the event success/failure determination section Y251 determines that the gathering event is a success in the event success/failure determination (step YS11: YES), the reward giving section Y260 gives the reward of the reward content Y555 to the user of the receiver Y551 in accordance with the reward data Y550 of the gathering event (step YS13). At this time, the accomplishment degree determination section Y261 performs as appropriate the first accomplishment degree determination process to determine the accomplishment degree based on the gathered number, or the second accomplishment degree determination process to determine the accomplishment degree based on the gathering time, so that the reward of the reward content corresponding to the determined accomplishment degree is given. For example, when the reward content includes the setting to give a game object, the reward giving section Y260 adds the game object to the owned object list Y513 of the user of the receiver. Furthermore, when the reward content includes the setting to execute a game event, the reward giving section Y260 performs the execution control of the game event. When the reward content includes the setting to give a service reward, the reward giving section Y260 adds a coupon to the owned coupon list Y514 of the user of the receiver of the coupon.

Then, when the reward given at the step YS13 is the service reward (step YS15: YES), the advertising expense billing section Y263 performs the advertising expense billing process for billing the advertiser for the advertising expenses using the advertiser information in the advertisement setting Y553 (see FIG. 19) (step YS17).

After that, the flow returns to the step YS1 (step YS19: NO) to repeat the processes described above until the game ends. Then, when the match game ends (step YS19: YES), the flow of the processes is terminated.

As described above, according to the second embodiment, the gathering event that gathers the participating users at the given gathering place existing in the real space can be started in response to the gathering request operation by the directing user during the game that progresses based on the user positions that are the positions of the user terminals. Then, when the gathering event is successfully accomplished, the reward can be given to the directing user and/or the participating user. As a result, a system for executing the gathering event that gathers the users playing the game can be provided to the game using the real space as the play filed, so that the new interest can be added to the game.

Modification examples relating to the second embodiment include following modification examples.

### Modification Example 1

According to the second embodiment, the game system Y1000 of the client-server type is described as an example. However, this should not be construed in a limiting sense. For example, the game system may be implemented by peer-to-peer connection among a plurality of user terminals Y1500. In such a case, any of the user terminals Y1500 performs the functions of the server system Y1100 in the second embodiment. Alternatively, the plurality of user terminals Y1500 may share the functions of the game management section Y230.

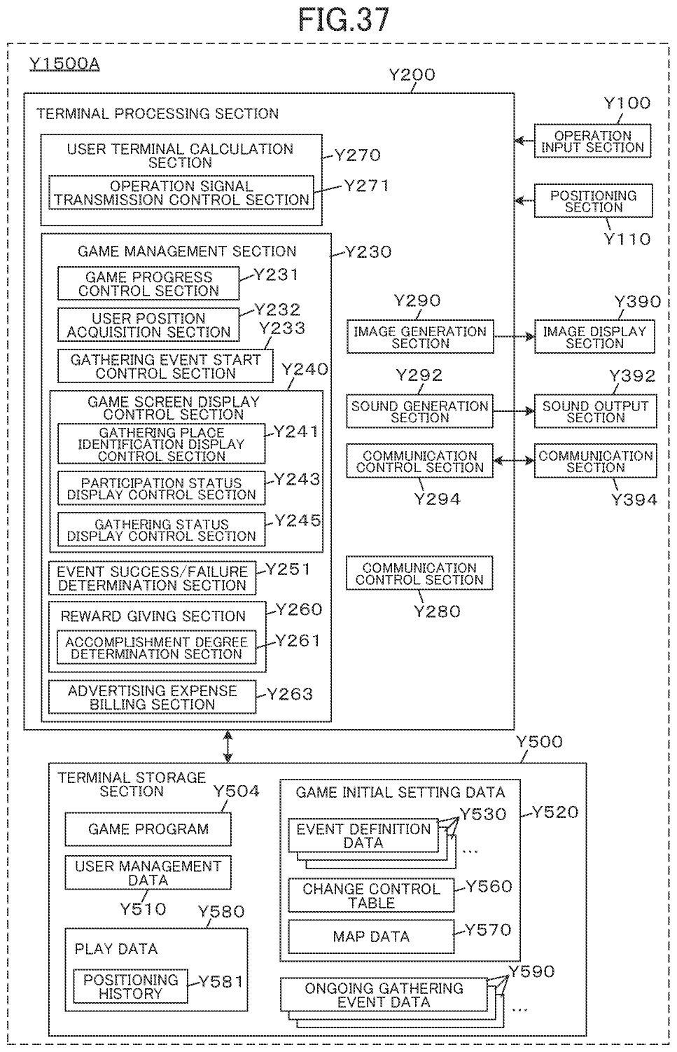

For example, FIG. 37 illustrates an example of a functional configuration of a user terminal Y1500A sharing the functions of the server system Y1100 in the second embodiment. In FIG. 37, common reference signs are given to components similar to the components in the second embodiment. In this case, the server system Y1100 mainly performs user registration and management of registration information, and provides the information in response to a request from the user terminal Y1500A.

As illustrated in FIG. 37, in the user terminal Y1500A according to the present modification example, the terminal processing section Y200 includes the game management section Y230, and the game screen display control section Y273 is omitted. That is, the user terminal Y1500A according to the present modification example does not acquire data for displaying an image of the game screen from the server system Y1100, but the game management section Y230 of the user terminal Y1500A performs the process related to the game management to control the game progress, and generates the image of the game screen. The terminal storage section Y500 of this user terminal Y1500A stores a game program Y504 for causing the terminal processing section Y200 to function as the user terminal calculation section Y270 and the game management section Y230. The terminal storage section Y500 also stores the user management data Y510 and the play data Y580 related to the user using the user terminal Y1500A, the game initial setting data Y520, and the ongoing gathering event data Y590.

The flow of the processes performed by the user terminal Y1500A according to the present modification example is basically the same as the flow in the flowchart in FIG. 36. You may read that the game management section Y230 of the user terminal Y1500A performs the steps.

According to the present modification example, the same advantageous effects as those in the second embodiment can be obtained. The user terminal Y1500A may be partially in charge of the functions of the game management section Y230, instead of being entirely in charge of the functions.

### Modification Example 2

Furthermore, according to the second embodiment, the operation to use the event execution item is accepted as the gathering request operation, and the user who has performed this operation is set as the directing user. However, a condition for becoming the directing user may be set. That is, a user who satisfies a predetermined gathering request operation permitting condition may be allowed to become the directing user, and the gathering request operation is accepted from this user. In such a case, the gathering request operation permitting condition may be included in the event definition data Y530. In particular, the gathering request operation permitting condition may include a setting requiring that the player level have reached a predetermined level, that the user have spent the points of a predetermined amount, that the user have participated in the gathering event before, or the like, or a combination thereof.

Alternatively, a specific user may be allowed to become a directing user. For example, in a case of a game that the users are divided into teams to compete, the user set as the team leader may become the directing user. That is, only the user serving as the team leader has an execution right for the gathering event, and performs the gathering request operation. In such a case, members on the same team as the team leader who has performed the gathering request operation may be set as the participating users in the gathering event.

### Modification Example 3

Furthermore, according to the second embodiment, the users who satisfy the participation condition Y543 (see FIG. 19) of the gathering event to be executed are compulsorily made the participating users. On the contrary, invitation for participation in the gathering event may be made to predetermined target users playing the game, and the target users who announced their participation may be made the participating users.

For example, entire users playing the game can be made the target users. Alternatively, part of the entire users may be made the target users. This can be implemented by setting a condition for becoming the target user (a condition for participating in the event) beforehand, and setting the users who satisfy the condition as the target users. For example, the condition may include a setting requiring that the user be enrolled in the friend registration of the directing user, that the player level have reached a predetermined level, that the user have spent the points of a predetermined amount, or the like.

According to the present modification example, the gathering event start control section Y233 in the server system Y1100 performs a control for displaying an announcement screen for announcing the execution of the gathering event on the user terminal Y1500 of each target user before the start control of the gathering event in response to a predetermined announcement operation by the directing user. As a result, the announcement is made only to the target users, and the content of the announcement is not open to other users.

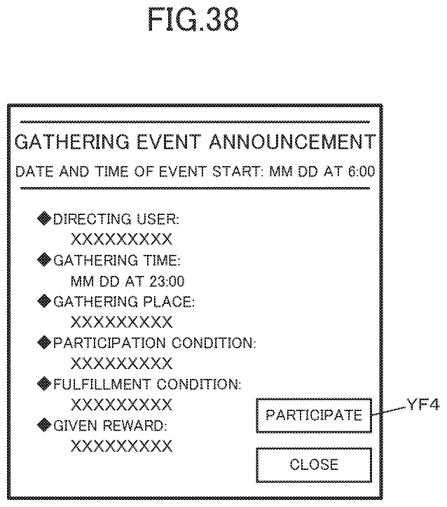

FIG. 38 is a diagram illustrating an example of the announcement screen. As illustrated in FIG. 38, the announcement screen shows the content of the gathering event to be executed, that is, a start date and time, a directing user, a gathering place, a gathering time, a participation condition, a fulfillment condition, a given reward of the gathering event, for example, and a participation operation made by a participation button YF4 is accepted. The target users check the content of the gathering event to be executed on the announcement screen of the gathering event, and perform the participation operation by touching the participation button YF4 for participation.

The gathering event start control section Y233 accepts the participation operation for the gathering event performed on the user terminals Y1500 of the target users until a predetermined announcement period ends. Acceptance of the participation operation may be closed when a predetermined time period has passed after the announcement. Alternatively, a quota may be set for each gathering event to be executed beforehand, and the acceptance may be closed when the number of participation operations reaches the quota of the gathering event. Accordingly, the target users who performed the participation operations during the announcement period are set as the participating users of the gathering event.

After that, the server system Y1100 controls the start of the gathering event announced, and executes the gathering event in a manner similar to that in the second embodiment. In a case that the start date and time of the gathering event is fixed in the announcement, the server system Y1100 performs the start control when the start time comes.

### Modification Example 4

Furthermore, as for the fulfillment condition Y544 in the event definition data Y530 (see FIG. 19), a degree of difficulty may be set correspondingly to the content of the condition, and the reward corresponding to the degree of the difficulty may be given. In such a case, the reward content Y555 includes the content of the reward corresponding to the degree of difficulty of the fulfillment condition Y544. In particular, the reward content may be adjusted such that the rareness degree of a game object to be given becomes higher or a discount rate of the coupon becomes higher as the degree of difficulty becomes higher, for example.

### Modification Example 5

Furthermore, according to the second embodiment, the content of the gathering event is set as the event definition data Y530 beforehand. However, the directing user may specify the various event detail items such as the gathering place, the gathering time, the fulfillment condition, or the reward. In such a case, the server system Y1100 accepts a specifying operation of the event detail items before the gathering request operation. Then, when the server system Y1100 detects the specifying operation on the user terminal Y1500 of the directing user, the server system Y1100 sets the respective event control items in accordance with the specifying operation, and then accepts the gathering request operation by the directing user. Then, upon acceptance of the gathering request operation, the server system Y1100 controls the start of the gathering event, and executes the gathering event based on the event control items set in accordance with the specifying operation. As a result, the directing user can determine the content of the gathering event to be executed.

### Modification Example 6

Furthermore, according to the second embodiment, the event success/failure determination is made with the prerequisite condition requiring that the participating user arrive at the gathering place by the gathering time. However, the event success/failure determination may be made with a prerequisite condition requiring that the participating user arrive at the gathering place without restriction on the arrival time. In such a case, the gathering event may be terminated when a gathered number of participating users reaches a predetermined number. The reward content Y555 in this case is preferably set in order of arrival as in the example in FIG. 25.

### Modification Example 7

Furthermore, the content of the game that the second embodiment can be applied to is not especially limited, and may be any game if it progresses based on the user position. For example, the game may be a game for collecting hidden game objects such as characters or items while the user moves in the real space, a game for raising a character using collected items or the like, or a game for fighting by a player character operated by a user, for example.

### Modification Example 8

In the second embodiment, the game content is described as an example of the content. However, in addition to the game content, the second embodiment can be applied to any other content if the content allows the user using the user terminal having the positioning function to enjoy the real space as the play field. For example, the second embodiment can be applied to the event content for an activity event of sports where a gathering place is specified, and participants compete in teams for time to gather at the gathering place, or the event content for orienteering where participants advance in order in search of the gathering place.

Although only some embodiments of the present invention have been described in detail above, those skilled in the art will readily appreciate that many modifications are possible in the embodiments without materially departing from the novel teachings and advantages of this invention. Accordingly, all such modifications are intended to be included within scope of this invention.

What is claimed is:

1. A computer system comprising at least one processor or circuit programmed to perform:
a start control to control a start of a gathering event upon acceptance of a gathering request operation from a terminal of a directing user, the gathering event including any one of a first gathering event that gathers a user character of a participating user at a given gathering place in a virtual space and a second gathering event that gathers the participating user at a given gathering place existing in a real space;
a map image display control to control a display of a map image displaying the gathering place in an identifiable display mode on the terminal of the directing user and a terminal of the participating user;
an event success/failure determination to determine a success/failure of the gathering event; and
reward giving to give a given reward to at least one of the directing user and the participating user when the gathering event is determined to be a success in the event success/failure determination.

2. The computer system as defined in claim 1, wherein
the start control includes controlling the start of the first gathering event,
the map image display control includes controlling the display of the map image related to the virtual space, and
the event success/failure determination includes determining the success/failure of the gathering event using a position of the user character operated by the participating user.

3. The computer system as defined in claim 2, wherein
the start control includes setting, as a fulfillment condition of the gathering event, a condition related to actions of the user character of the participating user in the virtual space taken before the user character gathers at the gathering place, and
the event success/failure determination includes determining whether the user character of the participating user satisfies the fulfillment condition.

4. The computer system as defined in claim 3, wherein the start control includes setting the fulfillment condition for each participating user based on intimacy between the participating user and the directing user.

5. The computer system as defined in claim 3, wherein, the start control includes
displaying, upon acceptance of the gathering request operation, the fulfillment condition of the gathering event with the gathering place on the terminal of a predetermined target user to announce execution of the gathering event,
accepting a participation operation from the terminal of the target user, and
controlling the start of the gathering event with the target user who has performed the participation operation as the participating user.

6. The computer system as defined in claim 3, wherein the at least one processor or circuit is further programmed to perform
a first participation status display control to display at least one of the fulfillment condition and a fulfilled status of the fulfillment condition on the terminal of the participating user in association with a display of the gathering place in the map image.

7. The computer system as defined in claim 2, wherein the at least one processor or circuit is further programmed to perform
a second participation status display control to display at least one of a remaining distance to the gathering place from the user character of the participating user and a position of the participating user in a ranking of the remaining distance of each participating user on the terminal of the participating user in association with a display of the gathering place in the map image.

8. The computer system as defined in claim 2, wherein the event success/failure determination includes determining the success/failure of the gathering event using the position of the user character operated by the participating user before a given gathering time or at the given gathering time.

9. The computer system as defined in claim 8, wherein the at least one processor or circuit is further programmed to perform
a third participation status display control to display at least one of the gathering time and a remaining time to the gathering time on the terminal of the participating user in association with a display of the gathering place in the map image.

10. The computer system as defined in claim 8, wherein the map image display control includes changing a display mode of the gathering place in the map image in accordance with a remaining time to the gathering time for the terminal of each participating user.

11. The computer system as defined in claim 2, wherein
each of the user is associated with a team to belong to, and
the start control includes controlling the start of the gathering event with a user on a same team as the directing user as the participating user upon acceptance of the gathering request operation.

12. The computer system as defined in claim 2, wherein the at least one processor or circuit is further programmed to perform
a gathering status display control to display a gathering status of each participating user based on a remaining distance to the gathering place from the user character of the participating user on the terminal of the directing user in association with a display of the gathering place in the map image.

13. The computer system as defined in claim 2, wherein the reward giving includes executing a given event as the reward.

14. The computer system as defined in claim 2, wherein the start control includes setting the gathering place based on an instruction from the directing user.

15. The computer system as defined in claim 2, wherein the map image display control includes changing a display mode of the gathering place in the map image in accordance with a remaining distance to the gathering place from the user character of the participating user for the terminal of each participating user.

16. The computer system as defined in claim 1, wherein the at least one processor or circuit is further programmed to perform
position acquiring to acquire a user position that is a position of the terminal;
the start control includes controlling the start of the second gathering event,
the map image display control includes controlling the display of the map image related to the real space, and
the event success/failure determination includes determining the success/failure of the gathering event using a gathering condition set based on the user position of the participating user.

17. The computer system as defined in claim 16, wherein
the gathering condition includes a position condition specifying that the user position of the participating user arrives at the gathering place, and
the event success/failure determination includes determining whether the user position of the participating user satisfies the position condition.

18. The computer system as defined in claim 16, wherein
the gathering condition includes a fulfillment condition of the gathering event relating to at least one of actions of the participating user and a progress status of the gathering event before the user position of the participating user arrives at the gathering place, and
the event success/failure determination includes determining whether the participating user satisfies the fulfillment condition.

19. The computer system as defined in claim 18, wherein the start control includes setting the fulfillment condition for each participating user based on a relationship between the participating user and the directing user.

20. The computer system as defined in claim 18, wherein
the fulfillment condition includes a degree of difficulty set beforehand, and
the reward giving includes giving a reward corresponding to the degree of difficulty to the participating user.

21. The computer system as defined in claim 16, wherein
the gathering condition includes a gathered number condition specifying a number of the participating users who arrived at the gathering place, and
the event success/failure determination includes determining whether the number of the participating users satisfies the gathered number condition.

22. The computer system as defined in claim 21, wherein the at least one processor or circuit is further programmed to perform
a first accomplishment degree determination to determine an accomplishment degree of the gathering condition based on the number of the participating users; and
the reward giving includes giving a reward corresponding to the accomplishment degree determined in the first accomplishment degree determination to at least one of the directing user and the participating user.

23. The computer system as defined in claim 16, wherein the at least one processor or circuit is further programmed to perform
a second accomplishment degree determination to calculate, for each participating user, an accomplishment degree of the gathering condition based on an arrival time of the participating user at the gathering place; and
the reward giving includes giving a reward corresponding to the accomplishment degree of the participating user determined in the second accomplishment degree determination to the participating user.

24. The computer system as defined in claim 16, wherein the reward giving includes executing a given event as the reward.

25. The computer system as defined in claim 16, wherein the reward giving includes giving a service reward that provides a given service set to the gathering place by a given advertiser as the reward.

26. The computer system as defined in claim 16, wherein the at least one processor or circuit is further programmed to perform
storing event definition data including gathering condition data specifying content of the gathering condition and reward data specifying content of the reward in association with a position in the real space set as the gathering place;
the start control includes accepting a selection operation of the event definition data from the terminal of the directing user, and controlling the start of the gathering event with the position in the real space associated with the event definition data selected as the gathering place,
the event success/failure determination includes determining the success/failure of the gathering event in accordance with the gathering condition data in the event definition data selected, and
the reward giving includes giving the reward in accordance with the reward data in the event definition data selected.

27. The computer system as defined in claim 16, wherein the map image display control includes, on the terminal of the participating user,
displaying a view image based on a current user position of the participating user in a switchable manner with the map image, and
displaying a direction display body indicating a direction of the gathering place in the view image.

28. The computer system as defined in claim 16, wherein the start control includes accepting the gathering request operation from a user who satisfies a predetermined gathering request operation permitting condition as the directing user.

29. The computer system as defined in claim 16, wherein the start control includes controlling the start of the gathering event with a user who has a predetermined relationship with the directing user as the participating user.

30. A system comprising:
the computer system as defined in claim 1;
and a user terminal configured to be able to communicate with the computer system.
